(19) United States
(12) Patent Application Publication
(10) Pub. No.: US 2023/0237593 A1
(43) Pub. Date: Jul. 27, 2023

(54) SYSTEMS AND METHODS FOR DETERMINING JUSTIFIED OPINIONS AMONG USERS IN A GROUP OF DIFFERENT OPINIONS

(71) Applicant: Deliberati LLC, Park City, UT (US)

(72) Inventor: Jonathan Robert Warden, Park City, UT (US)

(21) Appl. No.: 18/159,180

(22) Filed: Jan. 25, 2023

Related U.S. Application Data
(60) Provisional application No. 63/302,928, filed on Jan. 25, 2022.

(51) Int. Cl. G06Q 50/00

(52) U.S. Cl. CPC G06Q 50/01

(57) ABSTRACT

The disclosed techniques provide for automatically determining a score for a position represented in a digital content element based on digital signals derived from users interacting with the digital content element in an online forum. The techniques include receiving, by a computing system, digital content elements and digital signals indicating first and second positions in the online forum, the second position disagreeing with the first position, determining proportions of users associated with first and second groups corresponding to the first and second positions, determining, based on the proportions and digital signals, a conditional probability score that a random user accepts the first position given the random user accepts the second position, and determining, based on the conditional probability score and the digital signals, using a Bayesian reasoning algorithm, an informed probability score that a fully-informed user having access to all online discussion data would accept the first position.

### INCORPORATION BY REFERENCE

This application claims priority to U.S. Provisional Application Ser. No. 63/302,928, filed on Jan. 25, 2022, the disclosure of which is incorporated by reference in its entirety.

### TECHNICAL FIELD

This document describes devices, systems, and methods related to determining a justified opinion from among multiple divergent user opinions or preferences, such as through aggregating judgments as part of social media systems.

### BACKGROUND

Social media systems, such as social networks like FACEBOOK, TWITTER, and INSTAGRAM, have provided interfaces through which users are able to post content that others are able to effectively endorse, disagree with, or otherwise react to (among a variety of other response options). Such topic-based interactions among users can, in many instances, effectively make posts and the corresponding user reactions polls regarding the accuracy, reliability, and/or quality of the content in the posts. For example, if a user adds a post to a social media site and many users like it, an inference can be drawn that the content of the post is accurate and reliable (e.g., useful or representative of preferences of a group). Determinations of whether a post or other content in a social media system is accurate and reliable has been based on aggregate tallies of user reactions. For example, a post with a large number of likes and positive comments can be viewed as accurate and reliable based on the large positive response to the post by other users.

Social media and other systems have also included the ability to conduct express online polls in which an issue is posed to users, who are presented with an enumerated set of responses to select from. Such express online polls have included the ability for the poll creator, poll participants, and/or other users to view the results of the poll, either while it is ongoing or at the conclusion of a timeframe for the poll. Sometimes online polls have included options for users to comment on or to otherwise react to the outcome of the online polls, such as a comment section associated with the online poll in which users are able to discuss the issue presented on the online poll.

### SUMMARY

This document is generally directed to technology for analyzing large quantities of disparate digital information, such as user-generated digital content posted on and distributed via social media platforms and other online discussion forums, to determine the veracity and truth associated with various content, which can be used to remedy any of a variety of problems in the modern digital landscape related to propagation of false or fake information. The disclosed technology analyzes a variety of different signals related to digital content, including both the content itself as well as additional digital signals related to the content, such as user impressions for the digital content, digital responses registered by various users, additional content elements posted or distributed in relation to a content element, temporal relationships between content and other digital signatures, and others. The disclosed technology is configured to automatically and efficiently score content elements using the techniques and systems described throughout this document based on these signals to determine the veracity of content elements in a manner that does not require direct human review or content moderation, as well, which has been a chokepoint for social media platforms and other content-based platforms to effectively cull misleading information.

For example, the disclosed technology can be used for determining and identifying informed opinions for a group of users, which can represent the users' actual opinions if they were more fully informed of facts and other related information pertaining to the formation of the opinion. The disclosed technology can aim to produce more intelligent and informed group judgments that better represent users' collective knowledge and intelligence. The disclosed technology can determine informed opinions (also referred to as justified opinions) based on determined probabilities that one or more different opinions are justified for a group of people. For example, a common opinion poll can estimate an average opinion of a group. However, the average opinion may not be well-informed or justified. A justified opinion, which can be determined using Bayesian reasoning techniques as described throughout this disclosure, can be an opinion that the average member of the group should hold if they were more informed, such as through participating in more than one part of a distributed deliberation involving a group of people. Using the disclosed techniques, Bayesian inferences can be generated to estimate what a member of the group would believe if they only held beliefs justified by arguments made during the distributed deliberation. As a result, the disclosed techniques can be used to product collective group judgements that can be more intelligent than those judgements made by any individual in the group.

Using the disclosed technology, a computer system can determine a justified opinion of a group of users based on receiving poll results having a first group and a second group, determining counts of users associated with each of the first group and the second group, determining a joint probability distribution for the poll based on the counts of users associated with each of the first and the second group, and determining a conditional probability for the poll using Bayesian reasoning to identify a quantity of users from the first group who would accept the poll results associated with the second group. As an illustrative example, a poll can have a probability of a first belief and a probability of a second belief, the first belief's probability being greater than the second belief's probability (e.g., more users in the group support the first belief than the second belief). Evidence can also exist that supports the first belief but evidence may not exist that supports the second belief. Using the disclosed technology and the Bayesian reasoning described herein, the computer system can determine that a possibility probability of the first belief can be 100% because this belief is supported by evidence and the probability of the first belief is greater than the probability of the second belief. This can indicate that the first belief is justified and thus would be expected to be the belief of another user in the group. If, on the other hand, the probability of the first belief is equal to the probability of the second belief, then the possibility probability for each of the beliefs can be 50%, meaning both of the first and second beliefs may be justified.

The disclosed technology can be performed by any of a variety of appropriate computers, computer systems, cloud-based services, computing devices, and/or network of devices. Moreover, one or more software algorithms and rule engines can be implemented to perform the disclosed techniques. The following detailed description provides many illustrative examples of the disclosed techniques and are not intended to be limiting examples.

For example, the disclosed technology can be integrated into and implemented as part of different social media platforms where users express, share, react to, vote on, and/or discuss posted content (e.g., FACEBOOK, TWITTER, TWITTER BIRDWATCH, TWITTER SPACES, INSTAGRAM, TIK TOK, ZOOM, CLUBHOUSE, TWITCH, etc.). For example, the disclosed technology can be implemented as part of text-based social media platforms (e.g., TWITTER), image and video-based social media platforms (e.g., INSTAGRAM, YOUTUBE), multimedia social medial platforms (e.g., FACEBOOK, SNAP), audio social networks (e.g., TWITTER SPACES, CLUBHOUSE) where users can enter and communicate in audio chat rooms, and/or combinations thereof. Users can provide inputs (e.g., text, images, audio) into social media interfaces (e.g., mobile app, web browser application) provided on client devices (e.g., smartphone, laptop computer, desktop computer, tablet) that can express opinions. Other users can have the ability to respond to comments made by other users in any of a variety of ways (e.g., audio response, emoji reaction, textual response, motion-based response, gesture-based response, facial expression detection, eye tracking), and to otherwise interact with content posted, shared, or commented on by other users. Such interactions can be used as inputs and data for the disclosed technology to determine justified opinions, as described throughout this document.

One or more preferred embodiments include a method for automatically determining a score for a position represented in a digital content element based on digital signals derived from a group of users interacting with the digital content element in an online forum, the method including: receiving, by a computing system, online discussion data, which can include the digital content element and digital signals indicating a first position represented in the digital content element and a second position represented by one or more other digital content elements, the second position being in disagreement with the first position, determining, by the computing system, proportions of users associated with each of the first group and the second group based on the one or more other digital content elements and the digital signals, the proportions indicating first and second positions of an average user in each of the first group and the second group, determining, by the computing system and based on at least the proportions and the digital signals, a conditional probability score related to the first position that a random user accepts the first position of the first group given the random user accepts the second position of the second group, determining, by the computing system, based on at least the conditional probability score and the digital signals, and using a selected Bayesian reasoning algorithm, an informed probability score that a fully-informed user having access to all of the online discussion data indicating the first and second positions of the first group and the second group would accept the first position of the first group, and returning, by the computing system and based on the informed probability score, information indicating a justified opinion selected from among the first position and the second position represented in the digital content element and the one or more other digital content elements, the information being transmitted to at least one user computing device of at least one of the users for presentation in a graphical user interface (GUI) display.

The method can optionally include one or more of the following features. For example, the digital content element can be an online discussion or social media post. The online discussion can be hosted and provided to the users at respective user computing devices by an online discussion server system, and the respective user computing devices can be configured to: receive user input indicating responses taken by the respective users in response to information about the online discussion that is presented in graphical user interface (GUI) displays at the respective user computing devices, and provide the user input to the computing system as the online discussion data. The digital content element can be a TWEET in TWITTER. The digital content element can be a post on INSTAGRAM. The digital content element can be a post on FACEBOOK.

The method can also include determining, by the computing system, a score value for the justified opinion. The score value for the justified opinion can be a probability value. The score value for the justified opinion can be a likelihood that a position selected from amongst the first position and the second position is the justified opinion. The one or more other digital content elements can include at least one of a comment, post, like, upvote, downvote, heart, share, or reply.

As another example, the digital signals may indicate at least one of (i) an amount of time between a user viewing the digital content element and the user providing a response to the digital content element at their respective user device, (ii) whether the user views the digital content element and remains inactive, or (iii) whether the user views the digital content element and provides the response. Determining, by the computing system, a conditional probability score can include determining a ratio of the proportions. The method may also include determining, by the computing system, a joint probability score for the discussion based on the proportions of users associated with each of the first and the second group.

In some implementations, transmitting, by the computing system, the information to the at least one user computing device of the at least one of the users can cause the at least one user computing device to present the justified opinion at a top of the online forum presented in the GUI display. Sometimes, transmitting, by the computing system, the information to the at least one user computing device of the at least one of the users further may cause the at least one user computing device to push the first position of the first group or one or more other positions that do not include the justified opinion to a bottom of the online forum presented in the GUI display. The first position of the first group and the one or more other positions can be presented in the online forum in the GUI display in a ranked order, the ranked order being based on most popular to least popular position. A most popular position can correspond to more user responses than a least popular position. The responses can include at least one of likes, hearts, shares, or upvotes. At least a portion of the one or more other digital content elements can correspond to the second position of the second group. At least a portion of the one or more other digital content elements can correspond to the first position of the first group.

The devices, system, and techniques described herein may provide one or more of the following advantages. For example, the disclosed technology can provide for assisting a group of people to make informed, justified decisions and/or votes in an online social platform. The disclosed technology can be used for any of a variety of purposes, such as for performing fact-checking functionality, particularly with regard to information that is spreading virally on the internet. As yet another example, the disclosed technology can apply to different online social platforms, not only formal polls or voting environments. As mentioned, the disclosed technology can be seamlessly integrated into existing social platforms.

The disclosed technology can provide technical solutions to technical problems related to online content distribution platforms. In particular, as noted above, moderating content in an effort to remove false or misleading information has been a significant challenge for social media platforms and other content distribution systems or online discussion forums, in part because these efforts often involve or require human involvement in the decision and determination of whether content is likely true or false. As a result, the responsiveness of content moderation in these systems has been somewhat slow, particularly when spread across large systems with vast quantities of digital data and information that rapidly grows at rates that human moderation struggles to keep pace with. The disclosed technology can provide a technical solution to these (and/or other) technical problems that arise in the digital and online space by providing technology that is able to efficiently, automatically, and reliably identify and determine the veracity of content elements without human involvement. This can permit for more responsive and better content moderation within online platforms. For example, the disclosed technology can capture a variety of digital signals from online content platforms related to a content element and can use those digital signals to automatically and efficiently determine scores indicating the veracity of content elements. These determinations can be used to more efficiently and quickly manage vast databases or other datasets of online content, which can in turn improve the operation of online distribution systems and other social media or online discussion forums/platforms by reducing the datasets from which they are drawing content and automatically improving upon data integrity within those systems.

Additionally, the disclosed technology is configured to more efficiently use computing resources to make these determinations, which can reduce the amount of memory (e.g., RAM), processor cycles, persistent data storage space, and network traffic being used. For instance, the disclosed technology described throughout this disclosure selectively uses specific digital signals related to content elements to generate better and more accurate determinations related to content veracity, which can reduce the computing resources that may otherwise be required using other techniques that may use a broader and more expansive base of digital signals.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a conceptual diagram of an example use case in which a jury verdict is determined using the disclosed techniques.

FIG. 2A is a conceptual diagram for determining a justified opinion for an online discussion using Bayesian reasoning techniques.

FIG. 2B illustrates an example use case for using a justified opinion that is determined in an online discussion based on the disclosed techniques.

FIG. 3 is a conceptual diagram of an example use case in which justified posts in an online discussion forum are identified and elevated in the online discussion forum using the disclosed techniques.

FIG. 4 is a conceptual diagram of an example use case in which probability of drawing a particular card from a deck of cards is determined using the disclosed techniques.

FIGS. 5A-B illustrate example arguments for determining a jury verdict using the disclosed techniques.

FIG. 6 illustrates another example use case in which a jury verdict is determined using the disclosed techniques.

FIG. 7 is a flowchart of a process for determining a justified opinion for a discussion using the disclosed techniques.

FIG. 8 is a system diagram having one or more components that can be used to perform the disclosed techniques.

FIG. 9 is a schematic diagram that shows an example of a computing device and a mobile computing device.

Like reference symbols in the various drawings indicate like elements.

### DETAILED DESCRIPTION OF ILLUSTRATIVE EMBODIMENTS

This document generally relates to technology for automatically determining justified, informed, or other intelligent group judgements amongst discussions, including but not limited to online discussion forums, social media posts, and other discussions that may arise in non-electronic environments. This document describes distributed Bayesian reasoning techniques, which can take the form of a hypothetical opinion poll in order to inform relevant users of an actual opinion poll about what they would believe if they had more information, not what the relevant users actually believe. The purpose of distributed Bayesian reasoning techniques is to produce more intelligent group judgements that better represent the relevant users' collective knowledge and intelligence.

As described herein, the disclosed technology can receive and/or determine an informed opinion of a group of relevant users who participated in a discussion about a topic of a discussion, as described in patent application Ser. No. 17/682,400, entitled INFORMED CONSENSUS DETERMINATION AMONG MULTIPLE DIVERGENT USER OPINIONS, which is incorporated herein by reference in its entirety, and are aware of all information that was shared during the discussion. However, in large groups, there may be many different discussions and branches of discussion that are challenging or impossible for one user to follow. As a result, critical information and arguments shared by some users in the group may not reach all users of the group. So instead of identifying and returning the informed opinion of the average group user, the disclosed technology can leverage distributed Bayesian reasoning techniques to infer, determine, or otherwise estimate a hypothetical informed opinion that the average group user would have if they all participated in the full discussion. The disclosed technology can leverage a set of mathematically optimal rules that an ideal rational being would use to revise their beliefs based on new information, which is sometimes called Bayesian inference. Accordingly, the disclosed technology can employ Bayesian inference to estimate an opinion of a hypothetical group user that (1) starts with the opinion of the average group user, (2) acquires the knowledge of all users in the group, and (3) is a Bayesian reasoner. As a result, the disclosed technology can determine an informed opinion of the entire group and provide the informed opinion to one or more users in the group in order to assist them in making more intelligent group and individual judgements, interactions, or decisions.

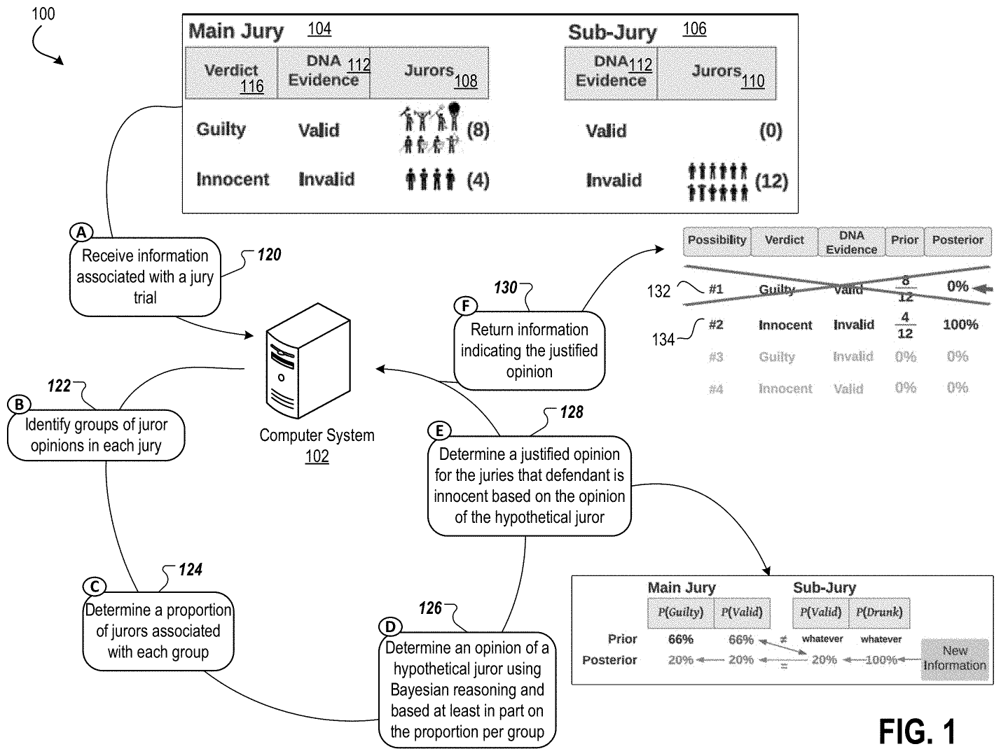

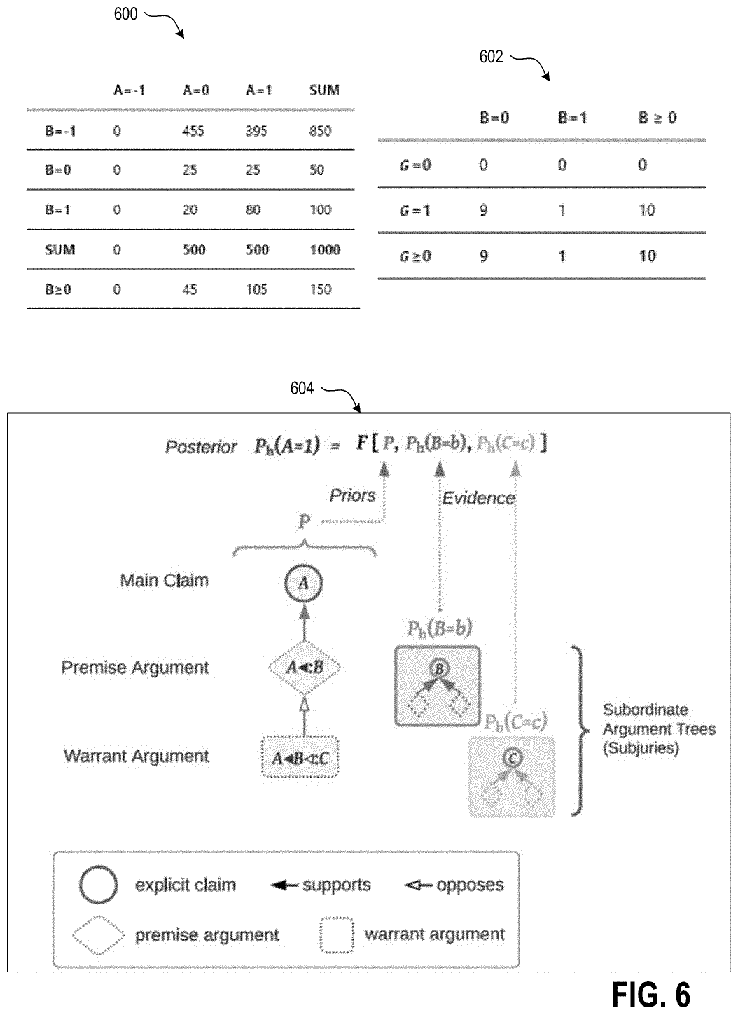

Referring to the figures, FIG. 1 is a conceptual diagram of an example use case 100 in which a jury verdict is determined using the disclosed techniques. Refer to FIG. 6 for further discussion about Bayesian techniques that are employed in the use case 100. A computer system 102 can perform the techniques described herein. The computer system 102 can be any type of computing system, computer, edge device, cloud-based system, computing device, remote computer system, and/or network of computers or devices.

In the illustrative user case 100 of FIG. 1, the computer system 102 can receive information associated with a jury trial (e.g., a discussion) (block A, 120). The information can be received from a data store and/or one or more other computing systems. In some implementations, the information can be provided to the computer system 102 as user input from a relevant user (e.g., a clerk in a court where the jury trial is held, a juror, a judge, etc.). The user input can be provided at a computing device of the relevant user and then transmitted to the computer system 102 or the user input can be provided directly at the computer system 102.

The information received in block A (120) can include main jury data 104 and sub-jury data 106. As an illustrative example, a group of 12 jurors can deliberate a verdict in a murder trial, and the verdict can be determined by a simple majority. As shown by the main jury data 104, 8 of jurors 108 believe that there was valid DNA evidence 112 and thus return a vote or verdict 116 of guilty. The remaining 4 jurors 108 think the DNA evidence 112 was not valid and thus return a vote or verdict 116 of innocent. In this example, the murder trial initially focused on the DNA evidence 112 and no other arguments supporting guilt or innocence were made during the trial.

The sub jury data 106, on the other hand, can represent a separate jury of 12 jurors 110 who may be drawn randomly from a same jury pool as the jurors 108 in the main jury data 104. The jurors 110 can be convened to determine whether or not the DNA evidence 112 is valid. For example, the jurors 110 can be shown evidence that a DNA lab technician was drunk. Based on seeing this evidence, all 12 of the jurors 110 can vote unanimously that the DNA evidence 112 is not valid.

The computer system 102 can identify groups of juror opinions in each jury in block B (122). The computer system 102 can determine a proportion of jurors associated with each group in block C (124). For example, the computer system 102 can identify a first group that 8 of the jurors 108 in the main jury data 104 returned the verdict 116 of guilty, a second group that 4 of the jurors 108 in the main jury data 104 returned the verdict 116 of innocent, a third group that 12 of the jurors 110 in the sub jury data 106 identified that the DNA evidence 112 was invalid.

The computer system 102 can determine an opinion of a hypothetical juror using Bayesian reasoning and based at least in part on the proportion per group (block D, 126). In the use case 100, the new information can include a verdict of the sub-jury, and the hypothetical juror revised their verdict based on this information. The computer system 102 can use Bayesian reasoning techniques, as described further in reference to FIG. 6, to estimate how the hypothetical juror would revise their beliefs after participating in a set of arbitrarily large and complex arguments involving any number of sub juries and/or sub-sub-juries.

The disclosed techniques can be used to assess complex questions or discussions, where a user may not be able to come close to being able to grasp complex issues involved, and essentially simulate a fully-informed user by breaking a problem in the complex questions down into parts and/or sub-parts. In some implementations, a separate trial of ideas for each bit of evidence and each bit of evidence supporting this evidence can be discerned, and so on for arbitrarily large argument graphs. Verdicts of sub-sub-juries deep in the argument graph can determine the verdict of higher-level juries and the results may propagate through the argument graph to determine the main verdict. This results in a kind of distributed brain, where the approximate reasoning of the average user is applied across the entire argument structure. This simulated brain may not be more intelligent than that of an average user, just more informed than the average user. It may not be capable of making inferences that the average user couldn't and wouldn't make from the same premises. It would simply conclude what the average user would conclude, based on the probability that they would accept the premises, and the probability that they would accept the conclusion given the premises.

The actual level of intelligence of the distributed brain depends on the users involved. Just as a fair trial requires a reasonable jury and competent lawyers, a fair trial of ideas may also require reasonable, informed participants. Yet, different groups of reasonable and informed users can produce different justified opinions. The result of this process should be thought of more like the result of a sophisticated opinion poll: it still depends on the group of users being polled. Therefore, distributed Bayesian reasoning is a technique or method of estimating what a specific group of users should believe, if they were all informed of all arguments that were shared in a thorough and fair deliberation.

A potential of collective intelligence is discovering not the opinion of the average user, nor the opinion of the most competent user, nor that of the most competent user in a group after deliberation has made them more competent, but an opinion that is beyond the abilities of any one user: the opinion that the most competent user in the group would form if they could surpass the limits of time and memory and comprehend all the relevant knowledge shared by all the other users of the group. This collective intelligence can be achieved through a process of distributed Bayesian reasoning as described herein.

In block E (128), the computer system can determine a justified opinion that the defendant is innocent based on the opinion of the hypothetical juror. The computer system can determine that the defendant is likely innocent since an average juror, had they participated in both the main jury and the sub-jury, would have found the DNA evidence 112 invalid. The determined justified opinion is that the defendant should be found innocent.

In some implementations, it is uncertain whether a random juror would have voted if they participated in both the main jury and the sub-jury, since correlation is not causation. It is uncertain what reasons any of the jurors may privately hold for making their decisions. Yet the defendant should be acquitted based on the sub jury data 106. Even if there are other good reasons to find the defendant guilty, none may be provided in the illustrative use case 100. If the trial has been fair, then both prosecutor and defendant have had their chance to make their case, provide reasons for their beliefs, and subject the beliefs of the other side to critical scrutiny. Accordingly, the reasons that jurors provide for their decisions can be treated as complete: any additional reasons jurors may still be withholding after deliberation should not influence the verdict 116. Therefore, a juror who finds the DNA evidence 112 valid should convict, and a juror who finds the DNA evidence 112 invalid should acquit, since there is no justification for any other opinion. Moreover, since the sub jury data 106 revealed that a randomly-selected juror would find the DNA evidence 112 invalid if they had participated in both the main jury and the sub-jury, the hypothetical juror who participated in both the main jury and the sub jury should find the defendant innocent.

The hypothetical juror described above can be considered a meta-reasoner, or a hypothetical fully-informed average juror. The meta-reasoner resembles the average juror in that it holds prior beliefs equal to the average beliefs of the jurors, but is fully-informed because the meta-reasoner holds beliefs for every relevant sub-jury. The meta-reasoner is also a Bayesian reasoner, especially since beliefs of the sub juries may be mutually inconsistent. For example, the sub jury unanimously believed the DNA evidence 112 was not valid, but most members of the main jury believed it was valid. Therefore, the meta-reasoner can update its beliefs so that its posterior beliefs are consistent. To do this, the meta-reasoner engages in a reasoning process as described herein. The evidence presented in the sub jury causes the meta-reasoner to update its belief about the DNA evidence 112, and this new belief can cause the meta-reasoner to update its belief about guilt, resulting in consistent posteriors. Suppose the evidence presented in the sub-jury was that the DNA lab technician was drunk, and as a consequence only 20% of jurors believe that the DNA evidence 112 was valid. The process that the meta-reasoner uses to update their beliefs is illustrated as shown in FIG. 1.

Information and belief propagates through the meta-reasoner's brain from the sub-juries towards the main jury. This means that the beliefs of the meta-reasoner depend on the argument structure. The DNA evidence 112 can be argued as a reason that the defendant is guilty, and not vice versa, so the meta-reasoner can update their belief in guilt as a consequence of updating their belief in the DNA evidence 112. Any reasons for rejecting the DNA evidence 112 can cause the meta-reasoner to reduce their belief in the DNA evidence 112, and in turn reduce their belief in guilt. A causal model derived from this argument structure can make the beliefs of the meta-reasoner deterministic, and can justify assumptions behind the mathematical formulas and rules used to calculate these beliefs, which are described further throughout this disclosure. However, the causal assumptions may not actually reflect the beliefs of the average juror. Even if the jurors' votes show there is a statistically significant correlation between belief in the DNA evidence and belief in guilt, it is not certain that the average juror doesn't believe in the DNA evidence 112 simply because they dislike the defendant and think the defendant is guilty. In a fair trial, each side would submit reasons that might effect jurors beliefs graph, and if any reasons are omitted, it is still possible to determine which verdict has been justified by the reasons that were given. Therefore, the posterior beliefs of the meta-reasoner can be thought of as the justified opinion of the group.

The priors of the meta-reasoner can be a set of joint probability distributions P₁, P₂, . . . , Pn over sets of claims (e.g. one set of possibilities for each “sub-jury”). Different probability distributions may cover the same claim, and the marginal probability for the same claim in different distributions may be different (e.g. P₀ (Valid)≠P₁ (Valid)). Thus the beliefs of the meta-reasoner may be inconsistent. The meta-reasoner updates their beliefs so that its posterior beliefs are consistent. It does this by using the posterior beliefs from one probability distribution as evidence for updating the beliefs of another, using the formulas and rules described herein. The argument structure determines the causal relationship between the meta-reasoner's beliefs (e.g. Drunk→Valid→Guilty) and thus the ordering of updates. The posterior beliefs of the meta-reasoner can thus be thought of as the justified opinion of the group.

The computer system 102 can return information indicating the justified opinion (block F, 130). A first possibility 132 of the juror opinion is that the defendant is guilty. A second possibility 134 of the juror opinion is that the defendant is innocent. A hypothetical Bayesian juror can have prior beliefs that are equal to average beliefs of the actual jurors in the main jury and the sub-jury. For example, as shown by the first possibility 132, the hypothetical juror can have an 8/12 probability that the DNA evidence 112 is valid AND the defendant is guilty. As shown by the second possibility 134, the hypothetical juror can have an 4/12 probability that the DNA evidence 112 is not valid AND the defendant is innocent. After this Bayesian juror learns new information—that the DNA evidence 112 is not valid—the computer system 102 determines, using the rules of Bayesian reasoning, that the hypothetical juror would reject the first possibility 132 (thus it's probability is updated to 0%), update the probability of the second possibility 134 to 100%, and thus adopt the second possibility 134. To determine the probabilities for the second possibility 134, the computer system 102 can perform the following equation (as an illustrative example):

$${P}_{j} ( A ) = {P}_{i} ( A \vert B ) = {P}_{i} ( A , B ) \div {P}_{i} ( B ) = 4 / 12 \div 4 / 12 = 100$$

Where A is the defendant being innocent, B is the DNA evidence 112 not being valid, Pᵢ is the prior possibility, and Pⱼ is the posterior probability. By definition of conditional probability, the second possibility 134 can be divided by the second possibility 134, as shown in the above equation.

If the verdict of the sub jury was not unanimous and if the DNA evidence 112 is probably invalid, the computer system 102 can determine that the Bayesian juror would conclude the defendant is probably innocent. The techniques described in reference to FIG. 1A can be used in combination with techniques that are disclosed in patent application Ser. No. 17/682,400, entitled INFORMED CONSENSUS DETERMINATION AMONG MULTIPLE DIVERGENT USER OPINIONS, which is incorporated herein by reference in its entirety.

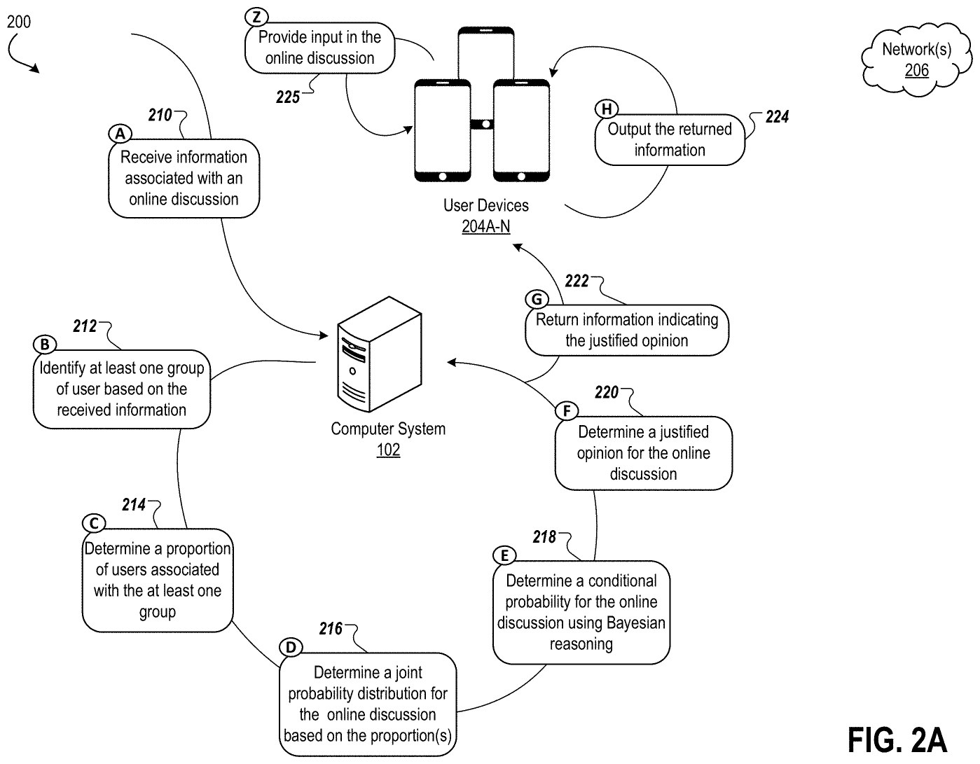

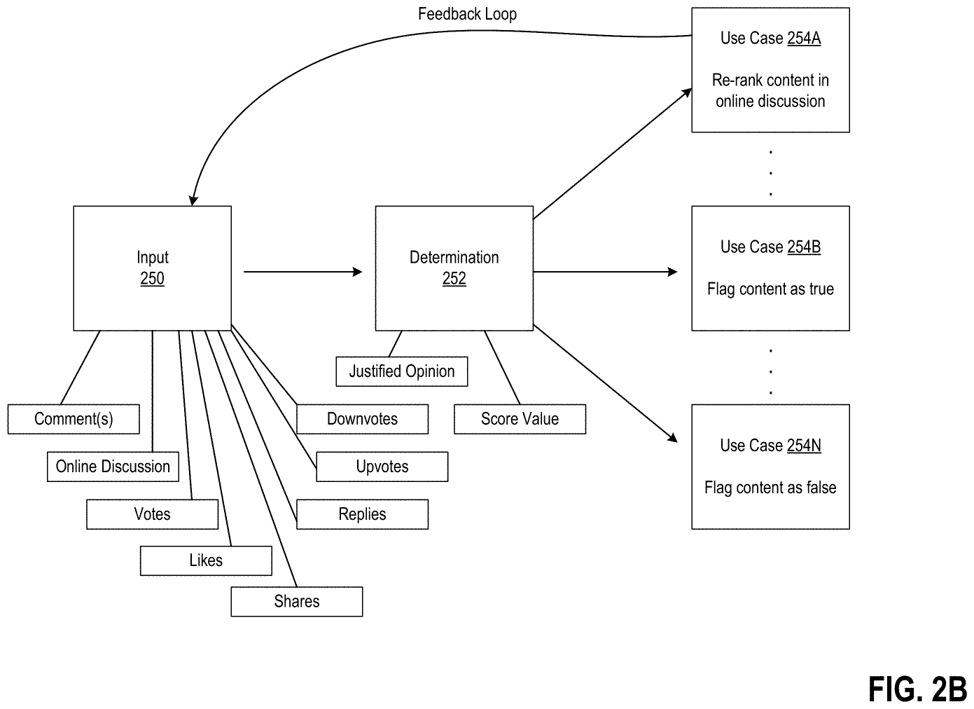

FIG. 2A is a conceptual diagram of a system 200 for determining a justified opinion for an online discussion using Bayesian reasoning techniques. The computer system 102 can communicate with user devices 204A-N (e.g., wired, wireless) over network(s) 206. The user devices 204A-N can include any computing devices (e.g., mobile phones, smart phones, tablets, laptops, computers, etc.) of users engaging in the online discussion. For example, the online discussion can be a social media post, such as a TWEET, that is posted or otherwise provided to the users at the user devices 204A-N by an online discussion forum (e.g., TWITTER). In the online discussion, the users can review or read comments, posts, upvotes, downvotes, or other types of reactions that users can make in response to content in the online discussion. The users can provide input at their respective devices 204A-N regarding the online discussion, such as commenting, liking one or more comments, downvoting, etc. (block Z, 225). Block Z (225) can be performed before, during, or after one or more of the following blocks described in the system 200.

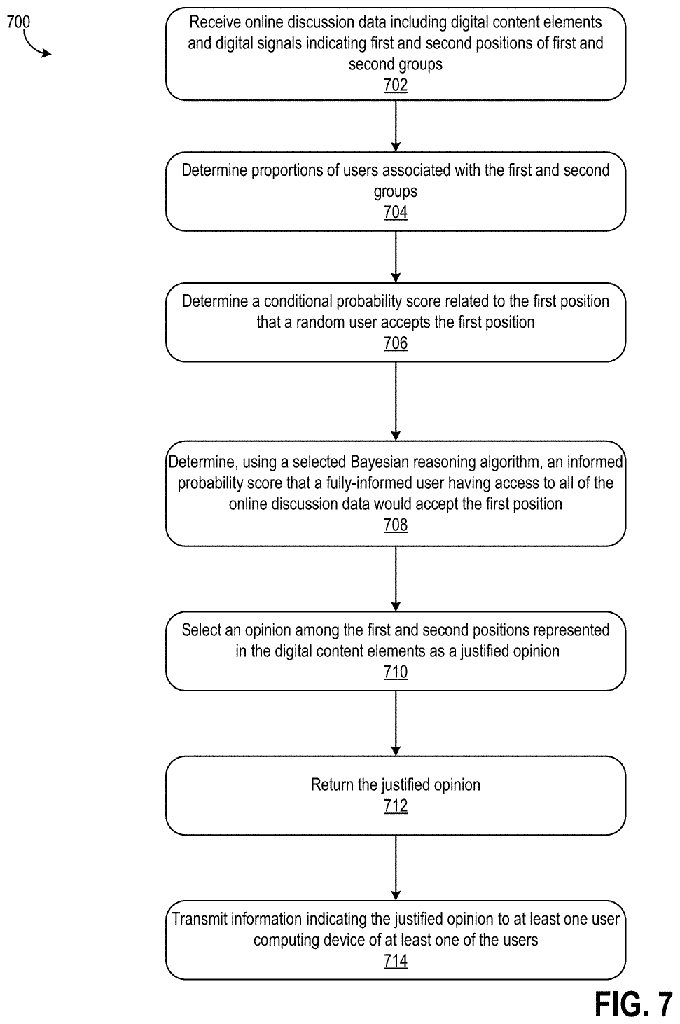

Still referring to the system 200, the computer system 102 can receive information associated with the online discussion in block A (210). The information can be received form the user devices 204A-N. For example, the information can include the user input provided at the devices 204A-N. The information can also be received from one or more other computing systems and/or data stores. The information can include historical data and/or real-time or near real-time data associated with the online discussion. The information can include digital content elements and/or digital signals that may or may not be associated with the digital content elements. The digital content elements can include but are not limited to online discussions, social media posts, comments, replies, shares, likes, hearts, upvotes, downvotes, or other types of reactions that users can make in a social media platform, online discussion forum, or other online platform. The digital signals may include temporal information or other information related to the digital content elements. Refer to FIG. 7 for further discussion.

The computer system 102 can identify at least one group of users based on the received information in block B (212). For example, the computer system 102 can identify users who express interest in a first opinion in the online discussion and users who express interest in a second opinion in the online discussion. The computer system 102 can identify the group(s) using techniques described in patent application Ser. No. 17/682,400, entitled INFORMED CONSENSUS DETERMINATION AMONG MULTIPLE DIVERGENT USER OPINIONS, which is incorporated herein by reference in its entirety.

In block C, the computer system 102 can determine a proportion of users associated with the at least one group (214). The proportion can be a count, such as a number of total users who are associated with the opinion of the at least one group. The proportion can additionally or alternatively be a ratio, percent, set, or other numeric value indicating how many users are aligned with or otherwise associated with the particular opinion of the at least one group.

The computer system 102 can determine a joint probability distribution for the online discussion based on the proportion(s) in block D (216). The joint probability distribution can be a numeric value or an integer value. For example, the joint probability distribution can be a score or score value. Refer to FIG. 6 for further discussion about determining the joint probability distribution.

In block E (218), the computer system 102 can determine a conditional probability for the online discussion using Bayesian reasoning techniques. The conditional probability can be a numeric value or an integer value. For example, the conditional probability can be a score or score value. Refer to FIG. 6 for further discussion about determining the conditional probability.

Accordingly, the computer system 102 can determine a justified opinion for the online discussion (block F, 220). The justified opinion can indicate a viewpoint of the online discussion that a hypothetical user who make if they were able to view all of the information associated with the online discussion. Refer to FIG. 6 for further discussion about determining the justified opinion. In some implementations, the justified opinion can be represented as a value, such as a score value, a numeric value, an integer value, and/or a probability. The justified opinion can, for example, be a score value where a higher score value indicates a higher likelihood that a particular opinion or position is the justified opinion for the online discussion. A lower score value, on the other hand, can indicate a lower likelihood that the particular opinion or position is the justified opinion for the online discussion.

The computer system 102 can return information indicating the justified opinion in block G (222). For example, the justified opinion, or content in the online discussion that supports the justified opinion can be outputted at one or more of the user devices 204A-N (block H, 224). This information can be elevated, highlighted, or otherwise presented near or at a top of the online discussion so as to bring users' attention to the justified opinion. As a result, the user(s) may make a more informed decision and change their opinion, comments, votes, etc., (e.g., by providing input in the online discussion in block Z, 225). Information that does not support the justified opinion can be presented lower in the online discussion, partially hidden from view in the online discussion, fully hidden from view in the online discussion, and/or shown in tandem/comparison with the information that supports the justified opinion. This information can be outputted at the user devices 204A-N of users who do not share the justified opinion (e.g., support an opinion adverse the justified opinion). The information can be outputted at the user devices 204A-N of both users who share and don't share the justified opinion.

FIG. 2B illustrates an example use case for using a justified opinion that is determined in an online discussion. As described in reference to FIGS. 1 and 2A, information can be received as input 250 to the computer system 102. The information received can include data about a discussion for which a justified opinion is to be determined, such as votes, comments, the online discussion, likes, shares, upvotes, downvotes, replies, and other reactions that users can make in the discussion. As some other examples, the inputs 250 can include temporal information or other data signals as described in reference to FIG. 7.

The computer system 102 can make a determination 252 based on the inputs 250. The determination 252 can be determining the justified opinion of the discussion using Bayesian techniques described herein. For example, the determination 252 can include the justified opinion and/or a score value. The score value can correspond to the justified opinion and/or represent a numeric likelihood that a particular opinion (and/or a particular one of the inputs 250) is the justified opinion of the discussion. Refer to FIG. 6 for further discussion about determining the score value and/or the justified opinion.

The determination 252 can be provided as output in a variety of use cases 254A-N. For example, the use case 254A can include re-ranking content in the online discussion based on the justified opinion and/or the score value and outputting the re-ranked content in the online discussion at one or more user devices described herein. The re-ranking can be performed by the computer system 102 and/or another computer system and/or server (e.g., a server that hosts the online discussion). The use case 254B can include flagging content in the online discussion as true or otherwise having some threshold level of veracity. Flagging the content can be performed by the computer system 102 and/or another computer system and/or server. In some implementations, the flagged content can be provided as a notification, message, alert, or other output at one or more of the user devices. The user case 254N can include flagging content in the online discussion as false, misleading, or otherwise having less than some threshold level of veracity. Similarly, the content can be flagged by the computer system 102 or another system/server. The flagged content can also be provided and outputted at one or more of the user devices, as described in reference to the disclosure of patent application Ser. No. 17/682,400, entitled INFORMED CONSENSUS DETERMINATION AMONG MULTIPLE DIVERGENT USER OPINIONS, which is incorporated herein by reference in its entirety.

One or more of the use cases 254A-N can be performed in response to or based on the determination 252. One or more of the use cases 254A-N and/or the determination 252 may also be fed back as input 250 in order to refine or improve the determination 252. For example, if one or more users change their opinions in the discussion based on the use case output 254A, data indicating the changed opinion(s) can be provided as the input 250 and used by the computer system 102 to regenerate the justified opinion as the determination 252.

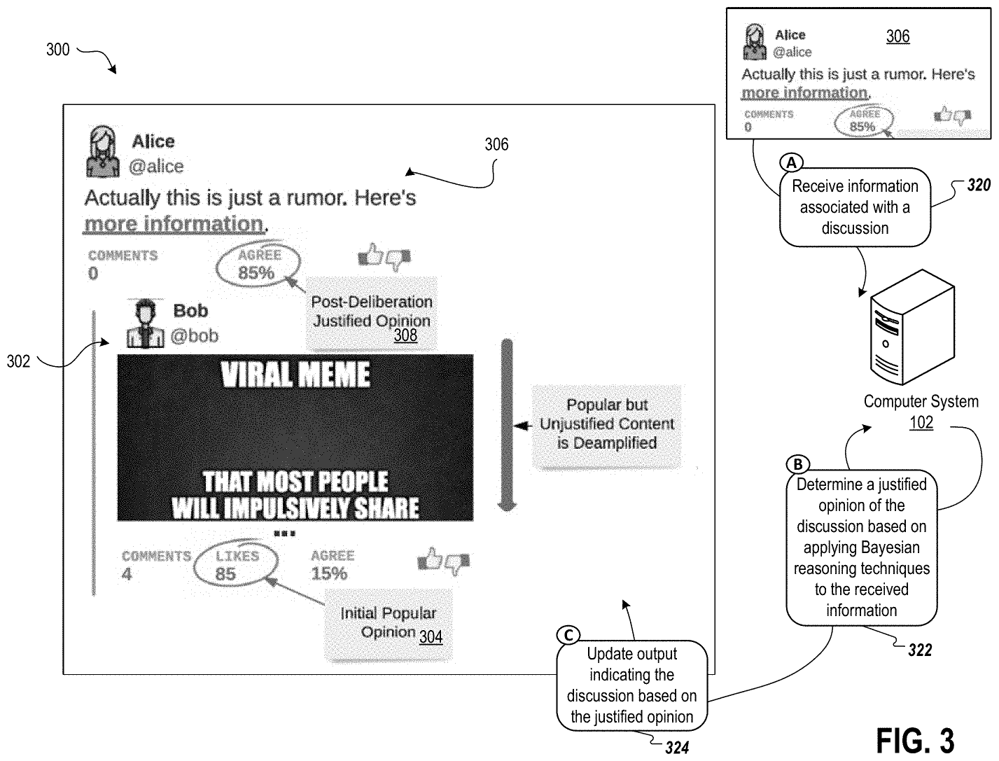

FIG. 3 is a conceptual diagram of an example use case in which justified posts in an online discussion forum are identified and elevated in the online discussion forum using the disclosed techniques. In this example, the computer system 102 can receive information associated with an online discussion in block A (320). For example, the computer system 102 can receive a comment 306 (e.g., digital content element), which can be a response to an online discussion post 302. The computer system 102 can receive other information associated with the comment 306 and/or the online discussion post 302, including but not limited to comments and how many comments were made in response to the comment 306 and/or the post 302, how many users agree or disagree with the comment 306 and/or the post 302, how many likes are given to the comment 306 and/or the online discussion post 302, and/or other relevant data.

The computer system 102 can determine a justified opinion of the discussion based on applying Bayesian reasoning techniques to the received information (block B, 322). For example, the computer system 102 can determine a score value for the justified opinion. Refer to FIG. 6 for further discussion about the Bayesian reasoning techniques that are applied.

Accordingly, the computer system 102 can update output 300 indicating the discussion based on the justified opinion (block C, 324). For example, the computer system 102 can determine that the initial post 302 had an initial popular opinion 304 based at least in part on receiving 85 likes. Although the post 302 may be popular, based on performing the Bayesian techniques described herein, the computer system 102 can determine that the comment 306 has a post-deliberation justified opinion 308 of 85% agreement amongst users. The computer system 102 can identify the comment 306 as the justified opinion and may elevate the comment 306 in the output 300 so as to bring the comment 306 to the attention of one or more users. Popular but unjustified content, such as the initial post 302, can be de-amplified or otherwise presented lower, partially hidden, or hidden in the output 300.

As described herein, the disclosed techniques can be used for determining better or otherwise informed group judgments. The techniques can be used in decision-support systems to help an organization harness the collective intelligence of its members. It can be used by journalists for collaborative fact-checking, or by blockchains for intelligent governance. And it can be used by social networks to de-amplify potentially viral information that individuals impulsively share but would probably not share if they knew more.

These techniques can also provide a mathematical basis for analyzing disagreement. They can identify top reasons users give for their beliefs, and counter-arguments that are most convincing. These techniques can identify if there is a “crux” of an argument somewhere in an argument graph that is a source of disagreement. These techniques can help users examine their own beliefs and discover unjustified assumptions and inconsistent reasoning.

Moreover, the techniques can be used to improve quality of online conversation. They can be used to create healthier feedback loops that reward and amplify comments that can stand up to scrutiny of the group, instead of just comments that generate engagement. They can also help identify areas to focus discussion that are most likely to result in consensus.

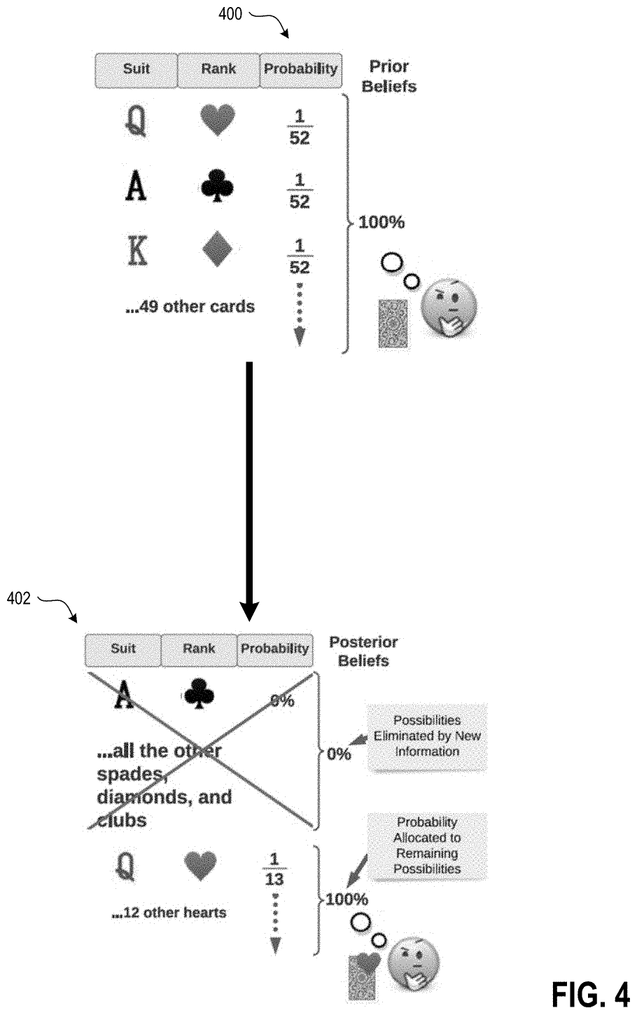

FIG. 4 is a conceptual diagram of an example use case in which probability of drawing a particular card from a deck of cards is determined using the disclosed techniques.

The computer system 102 described herein can represent a Bayesian reasoner and can start out with prior beliefs 400: a set of mutually exclusive and exhaustive possibilities for a situation at hand, and an estimated probability for each. For example, if a Bayesian reasoner draws a random card from a standard 52-card deck without turning it over, their prior beliefs about the card are that each of the 52 cards is equally likely.

The computer system 102 can revise such beliefs based on acquiring new information according to simple rules for reallocating probability. For example, if the computer system 102 identifies a particular card as being a heart (e.g., if the Bayesian reasoner peaks under one corner and learns that the card is a heart), then the computer system 102 can generate posterior beliefs 402 as follows: reject any possibilities that are incompatible with the new information (the other 3 suits) and reallocate probability to the remaining possibilities so that they sum to 100%. Thus, the new posterior beliefs 402 are that there are now 13 equal possibilities (the 13 hearts), each of which is 4 times more probable than it was before.

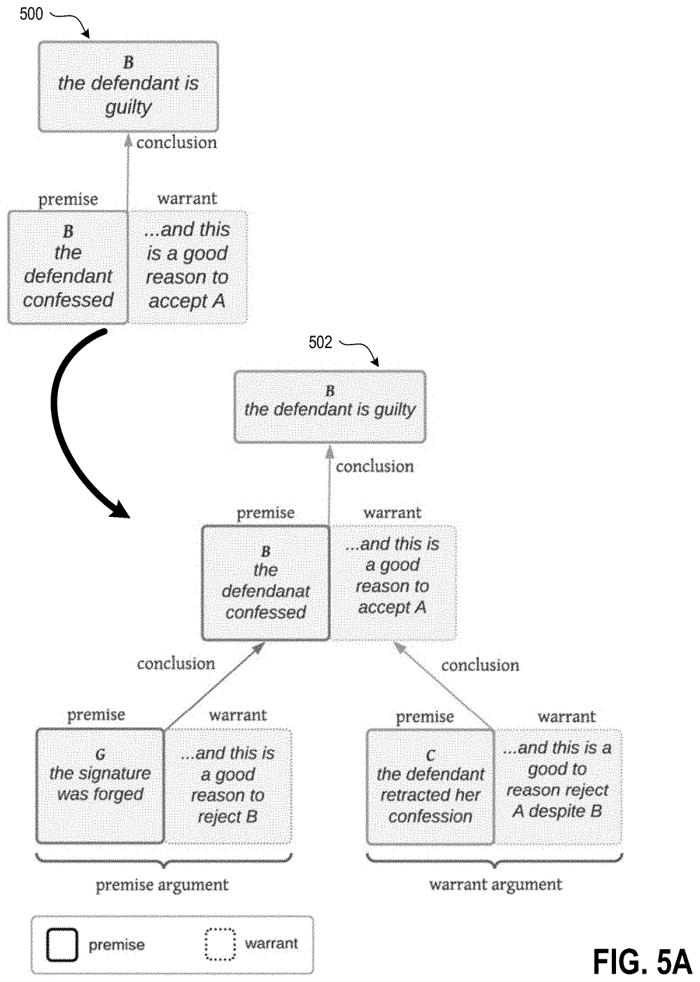

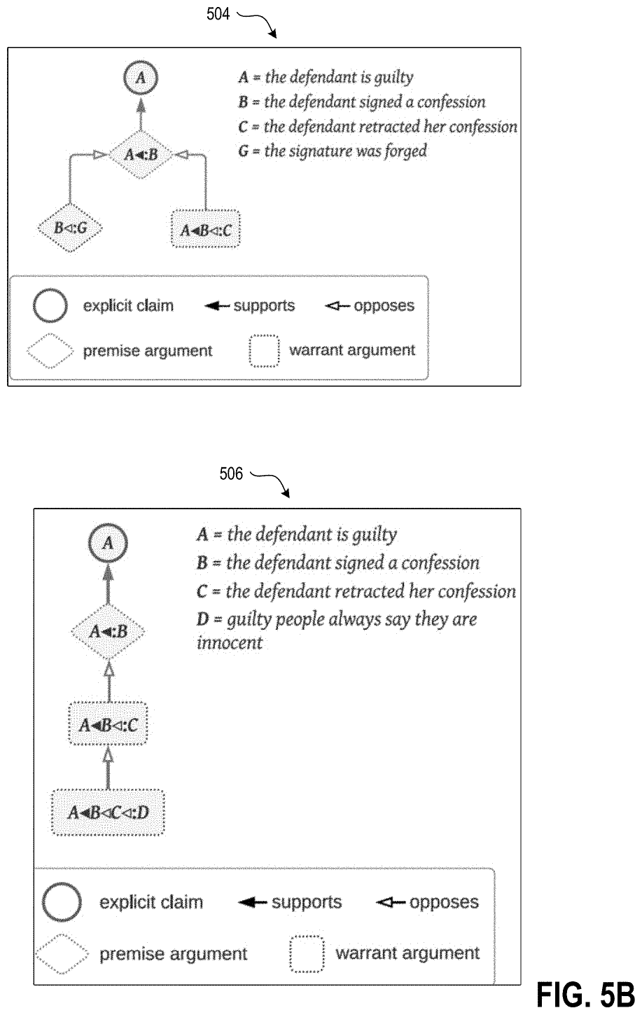

FIGS. 5A-B illustrate example arguments for determining a jury verdict using the disclosed techniques. Referring to both FIGS. 5A and 5B, a claim is a declarative sentence that users can accept or reject (agree with or disagree with). An argument can include at least 3 claims: a conclusion (the claim in dispute), a premise (a reason given to accept or reject the conclusion), and/or a warrant (an unstated claim that the premise, if accepted, is a good reason to accept or reject the conclusion). Diagram 500 shows a sample argument from a hypothetical jury trial, with labels for 3 parts of the argument.

Since any logical combination of premises can be treated as a single premise, an illustrative argument described herein can have one explicit premise. The premise may also be a conclusion of another argument, in some implementations. An argument may be worded in such a way that the premise is unclear (sarcasm, etc.). The premise can be synonymous with grounds, evidence, and/or data. The warrant can be thought of as a second unexpressed premise, comprising whatever might link the premise to the conclusion in the minds of the jurors or other users in a group. Anything that is actually stated in the argument can be part of the explicit premise, but something that is left unexpressed, even if it is nothing more than “this is a valid reason to believe the conclusion,” can be considered the warrant. In the illustrative example described herein, every argument may have a warrant and the warrant may be implicit. Therefore, in the diagram 500, the argument in support of conclusion (A) the defendant is guilty, has two halves: the premise (B) the defendant confessed (which can be the actual claim that has been made) and the warrant (the implied reason that the premise is a good reason to accept the conclusion).

The warrant of a supporting argument can be the claim that the premise is a good reason to accept the conclusion, and the warrant of an opposing argument can be the claim that the premise is a good reason to reject the conclusion. Supporting/opposing arguments may also support/oppose their conclusions. Making the distinction between premise and warrant allows to cleanly distinguish between premise arguments and warrant arguments. As shown in diagram 502, 2 arguments are added against B. The argument with premise (G) the signature was forged, opposes the premise (B) the defendant confessed. It is a reason for believing that B is not true, which is a premise argument. The argument with premise (C) the defendant retracted her confession, opposes the warrant of the argument with premise B, which is a reason for believing that even if B is true, A is not true. This is a warrant argument.

The same claim can be used as the premise of many different arguments. To identify arguments unambiguously, a computer system as described herein can use a notation that represents the argument itself, and not just the premise. An argument that supports conclusion A with premise B can use the following notation: A [symbol] :B. The premise is placed after the conclusion. This notation indicates that the fact the defendant confessed is a good reason to believe they are guilty. An argument that opposes conclusion A with premise B can use the following notation: A [symbol] :B. If the claim B is also used as the premise of some other argument, that would be a separate argument. An argument that opposes conclusion H with premise B would be represented as: H [symbol] :B. Premises such as (C) the defendant retracted her confession oppose the warrant of the argument A [symbol] :B and can be annotated as: A [symbol] B [symbol] :C. This argument can indicate that fact the defendant retracted their confession is a good reason to believe that they are not guilty despite the fact that they confessed.

The warrant of the argument A [symbol] :B can be represented as: A [symbol] B. An argument that opposes conclusion A [symbol] B with premise C can be (A [symbol] B) [symbol] :C. The parentheses (these operators are left-associative) can be dropped, so the notation for warrant arguments can be A [symbol] B [symbol] :C. The warrant A [symbol] B is a claim that B, if true, supports A, whereas the argument A [symbol] :B is the claim that B is true, and that it supports A. The former indicates that if the defendant confessed, that would be a good reason to believe they are guilty, whereas the latter can indicate that the fact that the defendant confessed is a good reason to believe they are guilty. The argument itself can be thought of as a claim that the premise and warrant are both true, which can be represented as:

A [symbol] :B=A [symbol] B∧B

A [symbol] :B=A [symbol] B∧B

Accordingly, the argument notations described above serve both to identify arguments and expose their logical structures.

Relevance or arguments can be considered and may be a subjective concept; yet it can be objectively defined in terms of beliefs of a Bayesian rational agent, such as a meta-reasoner described herein. For example, B is relevant to A if the rational agent is more or less likely to accept A given they accept B. Otherwise B is irrelevant to A. Or in other words, irrelevant means statistically independent—with respect to the beliefs of the rational agent. Relevant may also be considered a binary term—B is either relevant to A or it isn't. Therefore, relevance of B to A can be defined as a difference in the probability that the rational agent accepts A given they do/do not accept B. Therefore, if the probability function P represents the beliefs of the Bayesian rational agent, then the relevance of B to A is: P(A|B)−P(A|¬B). B may be irrelevant to A if the relevance of B to A is zero. The following can also be defined as support, in which B supports A if the rational agent is more likely to accept A given B (relevance is positive). The following can also be defined as opposition, in which B opposes A if the agent is less likely to accept A given B (relevance is negative). Accordingly, the warrant can be the claim that the premise supports/opposes the conclusion, with respect to the beliefs of some Bayesian rational agent.

As shown by diagram 504, the claim B can be relevant to claim A even if nobody has actually argued B in support of or opposition to A. As a result, for every relevant relationship between two claims, there exists a potential argument, but not necessarily an actual argument. Given a set of arguments that have actually been made in some situations, the diagram 504 can show relationships between the arguments. Each argument in the diagram 504 has one outgoing arrow, pointing to an argument or claim it supports or opposes. Note that an argument supports/opposes another argument if it supports/opposes that argument's premise or its warrant.

As shown in the diagram 504, the claim (G) the signature was forged opposes the claim (B) the defendant confessed. Since B is the premise of the argument A [symbol] :B, G opposes the premise of A [symbol] :B. Therefore, B [symbol] :G is a premise argument. The claim (C) the defendant retracted her confession, opposes the warrant of A [symbol] :B. It says that even if the premise B were true, it is not a good or sufficient reason to support A. Therefore, A [symbol] B [symbol] :C is a warrant argument. In this example, A [symbol] :B itself is a supporting premise argument because it is supporting the claim A. While claim A does not play the role of premise in any argument in this diagram 504, A [symbol] :B can be a premise argument because it is assumed that A could be playing the role of premise in some larger argument graph.

As shown in diagram 506, an argument can support or oppose a warrant of another warrant argument. In response to A [symbol] B [symbol] :C, one may argue (D) guilty people always say they are innocent. This argument would be written as A [symbol] B [symbol] C [symbol] :D. A response to this argument can be made, and/or a response to the response. The result can be a long argument thread. An argument thread is a premise argument followed by a chain of zero or more warrant arguments, which is illustrated in the diagram 506.

Argument threads can proceed along the lines of “A because B yes but not C, okay but D,” and so on. Each argument in the thread can be made in the context of all the previous arguments in the thread. The thread may be long, but jurors or other relevant users that are adding to the thread can be assumed to have followed the whole thread of the argument—even if they have not participated in the sub jury or other sub-discussions about each premise. The claims in the thread thus represents a shared context. Each argument in the thread is made in the context of all the previous claims in the thread, and presumes acceptance of all of them. For example, when someone argues that (C) the defendant retracted her confession it is clear from context that they accept (concede) that (B) the defendant confessed but still don't accept that (A) the defendant is guilty. If the arguer did not concede B, their response would be a premise argument (e.g. (G) the signature was d). Thus, the argument A [symbol] B [symbol] C [symbol] :D presumes acceptance of B and C: A person who makes this argument is giving D as a reason that somebody who accepts B and C should still accept or reject A. The warrant of the last argument in the thread can be interpreted as the claim that the premise, given acceptance of all preceding premises in the thread, is a good reason to accept or reject the root claim.

FIG. 6 illustrates another example use case in which a jury verdict is determined using the disclosed techniques. In this use case, a murder trial can be discussed in an online platform that allows the general public to vote on what they think the verdict should be and why. Initially, 1,000 users may vote on the root claim (A) the defendant is guilty, before any discussion has taken place on the platform. Then after this initial vote, a user can submit an argument claiming (B) the defendant confessed, and users are asked to vote on this claim. 150 out of the 1,000 users may vote on B, and some of these users may be convinced by B and changed their vote on A. Final votes can be determined using the disclosed techniques as shown in table 600. Votes can be represented using numeric values: 0=reject, 1=accept, and −1=didn't vote. According to this table, all 1,000 users voted on A, with 500 rejecting A (A=0) and 500 accepting A (A=1). But, only 150 users voted on B (B≥0).

Using the disclosed techniques, the computer system described herein can convert the counts shown in the table 600 to probabilities or score values, which represent beliefs of the average user participating in the discussion. A function c can be defined that returns values of a cell in the table 600. For example,

c(A=1)=500

c(A=1,B=0)=25

c( )=1000

From this, the disclosed computer system can define a function P for determining probability that a random user voted on something. For example:

$$P ( A = 1 ) = c ( A = 1 ) \div c ( ) = 500 \div 1000 = 50 \%$$

A conditional probability that a random user accepts A given they accept B can be determined by the computer system as:

$$P ( A = 1 \vert B = 1 ) = \frac{P ( A = 1 , B = 1 )}{P ( B = 1 )}$$

Conditional probabilities can be calculated by the computer system by taking the ratio of counts (e.g., probabilities, proportions) as such:

$$\begin{matrix}P ( A = 1 \vert B = 1 ) = \frac{P ( A = 1 , B = 1 )}{P ( B = 1 )} \\ = \frac{c ( A = 1 , B = 1 ) \div c ( )}{c ( B = 1 ) \div c ( )} \\ = \frac{c ( A = 1 , B = 1 )}{c ( B = 1 )}\end{matrix}$$

So that:

$$P ( A = 1 \vert B = 1 ) = \frac{80}{100} = 80 \%$$

In the example of FIG. 6, P(A=1) is only 50%, but P(A=1|B=1) is 80%, meaning jurors who accept claim B are more likely to accept claim A. So B apparently is an effective argument for A. On the other hand P(A=1|B=0)=25/50=50%. Users who reject B are not more likely to accept A. Amongst users who either accept or reject B, 70% of users accept A:

$$\begin{matrix}P ( A = 1 \vert B \geq 0 ) = \frac{c ( A = 1 , B \geq 1 )}{c ( B \geq 0 )} \\ = \frac{105}{150} \\ = 70 \%\end{matrix}$$

Accordingly, FIG. 6 shows that arguments can change minds, especially if they provide new information. The users who voted on B were exposed to this argument, while some users who didn't vote on B may have formed their opinion on A before they even heard anyone make claim B. As an illustrative example, some participants in this online discussion may have come into the discussion ill-informed, the media coverage of the murder may have been shoddy, and/or some people may not have heard the claim (B) the defendant confessed before they were asked to vote on it. If they actually believe B, then they have an 80% chance of accepting A. The reason that simply voting on B increases the chance of accepting A is that most users who voted on B actually accept B:

$$\begin{matrix}P ( A = 1 \vert B \geq 0 ) = \frac{c ( B = 1 )}{c ( B \geq 0 )} \\ = \frac{100}{150} \\ = 66 \; 2 / 3 \%\end{matrix}$$

Since this is closer to 1 than to 0, P(A|B≥0) is closer to (A|B=1) than to P(A|B=0). As described herein, goal is to calculate the beliefs of the meta-reasoner: a hypothetical fully-informed juror who shares the knowledge of all the other jurors. The opinion of users who voted on B is a better estimate of this fully-informed opinion, because it is the opinion of users who have been exposed to any new information conveyed by the claim B. Therefore, the computer system described herein can determine that the users who voted on B are the informed users. A first step can include estimating the beliefs of the meta-reasoner to define the informed probability function Pᵢ: Pᵢ(⋅)=P(⋅|B≥0). Therefore, Pᵢ(A=1)=P(A=1|B≥0), which has been calculated as 70%, as described above.

The informed opinion on A depends on the probability that informed users actually accept B. The equation for Pᵢ(A=1) can be rewritten in terms of Pᵢ(B=1). Since the set of users who accept B and the set that reject B partitions the set of users who voted on B, a law of total probability indicates that:

$${P}_{i} ( A = 1 ) = {\sum }_{b \geq 0} {P}_{i} ( B = b ) P ( A = 1 \vert B = b )$$

The 70% probability mentioned above can equally be determined using the low of total probability as follows:

$$\begin{matrix}{P}_{i} ( A = 1 ) = {P}_{i} ( B = 0 ) P ( A = 1 \vert B = 0 + \\ {P}_{i} ( B = 1 ) P ( A = 1 \vert B = 1 ) \\ = ( 1 - 66 \; 2 / 3 \% ) ( 50 \% ) + ( 66 \; 2 / 3 \% ) ( 80 \% ) = 70 \%\end{matrix}$$

This equation demonstrates exactly how the proportion of informed uses who accept B contributes to acceptance of A. This equation also shows what acceptance of A would be if this proportion were different.

Moreover, relevance can be defined in this example as: R(A, B)=P(A=1|B=1)−P(A=1|B=0), which can be rearranged to: Pᵢ(A=1)=P(A=1|B=0)+Pᵢ(B=1)R(A, B), which highlights the linear relationships between Pᵢ(A=1) and Pᵢ(B=1). With each unit increase in the meta-reasoner's belief in B, its belief in A increases by R(A, B).

Table 602 refers to another example in which a second group of 10 jurors holds an argument about whether to accept B, and during this argument jurors voted on claim G, the signed confession was forged. The jurors unanimously accept G and find it convincing: only 1/10 jurors accept B after accepting G. The opinion of the meta-reasoner about B can be equal to the opinion of the second group of voters, since this opinion is more informed, reflecting any new information conveyed by G. A function Pₕ can be used by the computer system to determine the beliefs of the meta-reasoner. The beliefs of the meta-reasoner about B is the informed opinion on B: Pₕ(B=b)=P(B=b|G>=0). Therefore:

$$\begin{matrix}{P}_{h} ( B = 1 ) = P ( B = 1 \vert G >= 0 ) \\ = \frac{c ( B = 1 , G > 0 )}{c ( G >= 0 )} \\ = 1 / 10 = 10 \%\end{matrix}$$

To calculate the probability that a member of the first jury would accept A if they held the beliefs of the second jury about B, Pₕ(B=b) can be substituted in place of Pᵢ(B=b) in

$${P}_{i} ( A = 1 ) = {\sum }_{b \geq 0} {P}_{i} ( B = b ) P ( A = 1 \vert B = b )$$

$${P}_{h} ( A = 1 ) = {\sum }_{b \geq 0} {P}_{h} ( B = b ) P ( A = 1 \vert B = b )$$

$$\begin{matrix}{P}_{h} ( A = 1 ) = {P}_{h} ( B = 0 ) P ( A = 1 \vert B = 0 ) + \\ {P}_{h} ( B = 1 ) P ( A = 1 \vert B = 1 ) \\ = ( 1 - 10 \% ) ( 50 \% ) + ( 10 \% ) ( 80 \% ) \\ = 53 \%\end{matrix}$$

Accordingly, the posterior belief Pₕ(A=1) is very close to P(A=1|B=0)=50%— the average belief of users who voted on B but rejected it—because a fully-informed user would probably reject B.

The below formula can be used if it is assumed that the meta-reasoner forms their belief about (A) the defendant is guilty entirely based on their belief about (B) the defendant confessed, regardless of the reason for their belief in B. Their belief in (G) the signature was forged does not affect their belief in A directly, but only indirectly through B. On the other hand, assumptions cannot be made about independence between the premises in an argument thread. (C) the defendant retracted her confession does not affect belief in A only through B. Rather, B and C have, or may have, various possible combined effects on A. While a sub jury can be created to decide whether or not the meta-reasoner accepts C, a sub jury may not be useful to determine how their acceptance of C effects their acceptance of A. The main jury should consider B and C together, and thus indicate the probability that the average juror—and thus the meta-reasoner—would accept A given they accept B and C.

$${P}_{h} ( A = 1 ) = {\sum }_{b \geq 0} {P}_{h} ( B = b ) P ( A = 1 \vert B = b )$$

This formula may also be considered a front-door adjustment given a causal graph G→B→A (which can be based on Judea Pearl's work on graphical models):

$$\begin{matrix}{P}_{h} ( a ) = P ( a \vert do ( G \geq 0 ) , do ( B \geq 0 ) ) & \\ = P ( a \vert do ( G \geq 0 ) , B \geq 0 ) & back - door adj . on \{ \} \\ = {P}_{i} ( a \vert do ( G \geq 0 ) ) & definition of {P}_{i} ( 0 ) \\ = {\sum }_{b} {P}_{i} ( b \vert G \geq 0 ) \times & \\ {\sum }_{{g}^{′}} {P}_{i} ( a \vert {g}^{′} , b ) {P}_{i} ( {g}^{′} ) & front - door adj . on \{ B \} \\ {\sum }_{b} {P}_{i} ( b \vert G \geq 0 ) {P}_{i} ( a \vert b ) & law of total prob . \\ = {\sum }_{b \geq 0} P ( b \vert G \geq 0 ) P ( a \vert b ) & definition of {P}_{i} ( 0 ) \\ = {\sum }_{b \geq 0} {P}_{h} ( b ) P ( a \vert b ) & definition of {P}_{h} ( 2 )\end{matrix}$$

The last expression shown above is

$${P}_{h} ( A = 1 ) = {\sum }_{b \geq 0} {P}_{h} ( B = b ) P ( A = 1 \vert B = b ) ,$$

except using notation of a, b, . . . for A=a, B=b, etc.

This formula can additionally or alternatively be Jeffrey's Rule, which is a general rule for Bayesian belief revision for situations where new information may come with uncertainty.

Referring to diagram 604 in FIG. 6, the computer system described herein can calculate the opinion of the meta-reasoner after argument C is made. The definition of the informed opinion can be updated. Previously, the informed opinion was defined as the opinion of users who voted on B; now that a second premise C exists in the argument thread, C can be included in the definition of informed opinion. However, each argument in a thread presumes acceptance of the previous premises in the thread. A user doesn't believe that (B) the defendant confessed, then there is no point trying to convince them that (C) she retracted her [non-existent] confession. C is merely argued as a way of convincing people who accept B that they still shouldn't accept A. Therefore, for users who reject B, what they think about C is irrelevant, whereas for users that do accept B, C might be new and relevant information. Accordingly, the computer system can define the informed opinion as the opinion of users who either reject B, or accept B and have voted on C:

Pᵢ(A=a)=P(A=a|B=0∨(B=1∧C≥0))

This can be rewritten or re-determined by the computer system using the law of total probability and some probability calculus. For example:

$${P}_{i} ( A = 1 ) = {P}_{i} ( B = 0 ) P ( A = 1 \vert B = 0 ) + {P}_{i} ( B = 1 ) {\sum }_{c \geq 0} {P}_{i} ( C = c \vert B = 1 ) \times P ( A = 1 \vert B = 1 , C = c )$$

Now, suppose a third sub jury holds a sub-trial about whether to accept C, giving Pₕ (C=c). The opinions of the sub juries Pₕ(B=b) and Pₕ(C=c) can be plugged in place of Pᵢ(B=b) and Pᵢ(C=c|B=1) as such:

$${P}_{h} ( A = 1 ) = {P}_{h} ( B = 0 ) P ( A = 1 \vert B = 0 ) + {P}_{h} ( B = 1 ) {\sum }_{c \geq 0} {P}_{i} ( C = c \vert B = 1 ) \times P ( A = 1 \vert B = 1 , C = c )$$

which provides the posterior belief of the meta-reasoner Pₕ(A=a) as a function of the prior probability function P and the evidence from the sub juries Pₕ(B=b) and Pₕ(C=The shorthand F[P, P(B=b), P(C=c)] refers to the above formula and is illustrated in the diagram 604.

As an illustrative example of the formula described in the diagram 604, suppose the following probabilities for users that voted on A and B are received:

| b | c | P(A = 1\|B = b,C = c) |
|---|---|---|
| 0 | −1 | 50% |
| 1 | 0 | 80% |
| 1 | 1 | 65% |

Then suppose that the beliefs from the sub juries are Pₕ(B=1)=80% and Pₕ(C=1)=60%. Using the formula in the diagram 604, the following is determined by the computer system:

$$\begin{matrix}{P}_{h} ( A = 1 ) = ( 1 - 80 \% ) \times 50 \% + \\ 80 \% \times ( 1 - 60 \% ) \times 80 \% + \\ 80 \%60 \% \times 65 \% \\ = 66.8 \%\end{matrix}$$

In some implementations, the formula in the diagram 604 can be rewritten as:

$${P}_{h} ( A = 1 ) = {\sum }_{b \geq 0} {P}_{h} ( B = b ) \times if b = 0 then P ( A = 1 \vert B = 0 ) else {\sum }_{c \geq 0} {P}_{h} ( C = c \vert B = 1 ) \times P ( A = 1 \vert B = 1 , C = c )$$

Under a there can be a thread with n premises β={(β1, β2, . . . , βn} such that:

$${P}_{h} ( α = 1 ) = {\sum }_{{b}_{1} \geq 0} {P}_{h} ( {β}_{1} = {b}_{1} ) \times if {b}_{1} = 0 then P ( α = 1 \vert {β}_{1} = 0 ) else {\sum }_{{b}_{2} \geq 0} {P}_{h} ( {β}_{2} = {b}_{2} ) \times if {b}_{2} = 0 then P ( α = 1 \vert {β}_{1} = 1 , {β}_{2} = 0 ) else … {\sum }_{{b}_{n} \geq 0} {P}_{h} ( {β}_{n} = {b}_{n} ) \times P ( α = 1 \vert {β}_{1} = 1 , {β}_{2} = 1 , … , {β}_{n} = 1 )$$

The function Pₕ can be recursive. The recursion may terminate when it reaches a terminal node in the argument graph—a claim without any premise arguments underneath it—in which case β=Ø and the function will return Pᵢ(α=1), which will return P(α=1). As a result, posterior beliefs of the meta-reasoner can then be calculated for complex argument trees, comprising arbitrarily long argument threads, and arbitrarily deep nesting of juries and sub-juries.

In some implementations, Bayesian hierarchical models can be used for sampling error and multiple argument threads. Regarding sampling error and sparse data, the informed probability Pᵢ can indicate the prior beliefs of the meta-reasoner. This can be calculated as the following ratio:

$${P}_{i} ( A = 1 \vert B = 1 ) = \frac{P ( A = 1 , B = 1 \vert B \geq 0 )}{P ( B = 1 \vert B \geq 0 )} = \frac{c ( A = 1 , B = 1 )}{c ( B = 1 )}$$

However, suppose only one user actually voted on both A and B and accepts both. Then c(A=1, B=1)=c(B=1)=1, and this ratio is 100%. A single vote from a single user may not provide much information. Thus, Bayesian hierarchical models provide a way of estimating the priors of the meta-reasoner based on the evidence in the form of arguments and votes.

Similarly, with regards to multiple argument threads (e.g., a premise argument followed by one or more warrant arguments), these are each separate dialogs and although at least one or 2 users may participate in each argument thread, it is also possible that different groups of users initiate and hold separate argument threads about a same claim, without participating in the other threads. Bayesian Belief Revision can therefore be used to propagate information through the mind of the meta-reasoner and estimate the justified opinion.

First, to solve the problem of sampling error and sparse data, consider that the probability P(A=1) is the probability that a randomly-selected juror from our jury pool (the people who actually voted) accepts A. This may not be the same as the probability that the meta-reasoner would accept A. The disclosed Bayesian techniques require priors: an estimate of this probability (or rather a distribution of possible probabilities), which may occur before having any data about how users vote. Then, rules of Bayesian techniques can be applied to combine the priors with data to generate or determine a posterior belief (e.g., a justified opinion).

An illustrative Bayesian solution is called a beta-Bernoulli distribution. ω can represent a prior estimate of the probability that the average juror accepts A before getting any vote data. κ can represent a prior estimate of the concentration of likely values around ω (high κ means low variance). N can equal c (A>=0), which can represent a number of users who voted on A. z can equal c(A=1), which can represent the number of those users who also agree with A. Then a posterior estimate of the probability that the average user accepts A is given they have voted on it is:

$$\frac{ω ( κ - 2 ) + 1 + z}{κ + N}$$

If this method is being implemented in a social platform, then the prior co can be based on historical data. For example, if in the past, the average accept/reject ratio for arguments submitted to the platform was 80%, then having nothing else to go on, 80% is a good estimate of co. The estimate of κ can also be made using historical data. This can be called Bayesian Averaging, which provides a weighted average of the prior co and the observed ratio z/N, with our data z/N, with the data z/N getting higher weight the larger the value of N.

Regarding the Bayesian Average probability function, when calculating values of P, the computer system described herein can determine ratios of counts from votes (e.g., the c function). For example, the formula for P(A=a) can be:

$$P ( A = a ) = \frac{c ( A = a )}{c ( )}$$

Where c( ) is the total number of voters. To use a Bayesian approach to estimate probabilities, instead of taking a ratio, the above 2 counts can be inserted into (0). Pᵥ can be defined as a new function:

$$P ( A = a ) = \frac{c ( A = a )}{c ( )}$$

The following function is defined:

$${P}_{v} ( α ) = \frac{ω ( κ - 2 ) + 1 + c ( α )}{κ + c ( )}$$

A conditional probability can be defined as:

$$P ( α \vert β ) = \frac{c ( α , β )}{c ( β )}$$

Therefore:

$${P}_{v} ( α \vert β ) = \frac{ω ( κ - 2 ) + 1 + c ( α , β )}{κ + c ( β )}$$

An actual value of Pᵥ(A=1). The priors can be selected by the computer system. Historically, for example, on average 80% voters accept root claims initially. So ω=80%. Moreover, variation in this distribution can be represented by κ=10. Thus:

$$\begin{matrix}{P}_{v} ( A = 1 ) = \frac{ω ( κ - 2 ) + 1 + c ( A = 1 )}{κ + c ( )} \\ = \frac{( 80 \% ) ( 10 - 2 ) + 1 + 500}{10 + 1000} \\ \underline{\approx } 50.23 \%\end{matrix}$$

In this example, a large amount of votes overwhelms a weaker prior, and thus the result is close to Pᵢ(A=a)=50%.

Regarding two-level Bayesian Averaging, originally the justified opinion formula in the case where an argument tree exists with a single premise argument is:

$${P}_{h} ( A = 1 ) = {\sum }_{b = 0}^{1} {P}_{i} ( A = 1 \vert B = b ) {P}_{h} ( B = b )$$

Now, Bayesian Averaging can be used by putting Pᵥ(A=1|B=b) in place of Pᵢ(A=1|B=b) to derive:

$${P}_{h} ( A = 1 ) = {\sum }_{b = 0}^{1} \frac{ω ( κ - 2 ) + 1 + c ( A = a , B = b )}{κ + c ( B = b )} {P}_{h} ( B = b )$$

As described above, Bayesian Averaging was used to estimate the probability that the average person accepts A (Pᵥ(A=1)=50.23%)), which seems like a reasonable prior for the estimate of Pᵥ(A=1|B=b). Before considering the 150 users who voted on B, a large amount of data can be assessed by the computer system to indicate that the average user has a roughly even chance of accepting A, an no prior reason to believe that accepting/rejecting B either increases or decreases this probability. Unless there is strong evidence showing accepting/rejecting B changes the probability that users accept/reject A, the computer system can assume that is does not.

However, if =Pᵥ(A=1) is used by the computer system as a prior for Pᵥ(A=1|B=b), there may be a an issue of double counting. Votes of users for whom A=1 and B=b as evidence for estimating Pᵥ(A=1) may be counted, and then the same votes may be counted as evidence for estimating Pᵥ(A=1|B=b). To avoid double counting, the prior should actually be Pᵥ(A=1|B b).

The priors for Pᵥ(A=1|B≠b), on the other hand, can be the same priors used to calculate Pᵥ(A=1), because there is no other data to base this on other than the historical data. Therefore, ω=80% and κ=10. Starting with B=1, the following is calculated by the computer system:

$$\begin{matrix}{P}_{v} ( A = 1 \vert B \neq 1 ) = \frac{ω ( κ - 2 ) + 1 + c ( A = 1 , B \neq 1 )}{κ + c ( B \neq 1 )} \\ = \frac{80}{10 + 90} \approx 46.96\end{matrix}$$

Now, ω=Pᵥ(A=1|B≠1) can be set as the prior for calculating Pᵥ(A=1|B=1). A large number of votes on A provide evidence for estimating ω=Pᵥ(A=a). But the estimate for κ can be based on prior expectations about the degree to which users are influenced by arguments. This information can come from observation of actual variance in the case of past arguments, which can be assessed and identified by the computer system described herein. If this is historically high, then κ should be low, and vice versa. For simplicity as an illustrative example, the same prior κ=10 can be used as described in above examples. The following can be calculated:

$$\begin{matrix}{P}_{v} ( A = 1 \vert B = 1 ) = \frac{{P}_{v} ( A = 1 \vert B \neq 1 ) ( κ - 2 ) + 1 + c ( A = 1 , B = 1 )}{κ + c ( B = 1 )} \\ \approx \frac{( 46.96 \% ) ( 10 - 2 ) + 1 + 80}{10 + 100} \\ \approx 77.05 \%\end{matrix}$$

The result from the above calculation is slightly lower than Pᵢ(A=1|B=1)=80. This is because there may still be a reasonably large number of votes on B, and these votes provide strong evidence for a posterior value of 80% that overpower the prior estimate.

FIG. 7 is a flowchart of a process 700 for determining a justified opinion for a discussion using the disclosed techniques. The process 700 can be performed for automatically determining a score for a position (e.g., opinion) represented in a digital content element based on digital signals derived from a group of users interacting with the digital content element in an online forum. The process 700 can be performed by the computer system 102. The process 700 can also be performed by one or more other computing systems, devices, and/or networks of computer systems/devices. For illustrative purposes, the process 700 is described from the perspective of a computer system.

Referring to the process 700 in FIG. 7, the computer system can receive online discussion data including digital content elements and digital signals indicating first and second positions of first and second groups. For example, the computer system can receive online discussion data, which can include the digital content element and digital signals indicating the first position represented in the digital content element and the second position represented by one or more other digital content elements. The second position can be in disagreement with the first position. The digital content elements can include online discussions, social media posts, comments, replies, likes, shares, upvotes, downvotes, or other types of reactions. In some implementations, at least a portion of the one or more other digital content elements may correspond to the second position of the second group. At least a portion of the one or more other digital content elements can correspond to the first position of the first group.

The digital signals can include a variety of information that may be associated with the digital content elements, including but not limited to temporal information. As an illustrative example, the digital signals can include information about when a user sees, views, or opens one or more of the digital content elements (and/or whether the user responds to the seen element(s)), when the user responds to the digital content elements (e.g., in response to seeing or viewing the element(s)), whether the user responds to the digital content elements (e.g., in response to seeing or viewing the element(s)), etc. The digital signals can indicate, for example, at least one of (i) an amount of time between a user viewing the digital content element and the user providing a response to the digital content element at their respective user device, (ii) whether the user views the digital content element and remains inactive, and/or (iii) whether the user views the digital content element and provides the response.

The digital content element, in illustrative examples, can include a TWEET in TWITTER, a post on INSTAGRAM, a post on FACEBOOK, or any other types of comments or posts that may be made in social media discussions, platforms, and forums.

In block 704, the computer system can determine proportions of users associated with the first and second groups. For example, the computer system can determine proportions of the users associated with each of the first group and the second group based on the one or more other digital content elements and the digital signals. The proportions indicate first and second positions of an average user in each of the first group and the second group.

The computer system can determine a conditional probability score related to the first position that a random user accepts the first position (block 706). The conditional probability score can be determined based on at least the proportions and the digital signals, where a conditional probability score related to the first position corresponds to a random user accepting the first position of the first group given the random user accepts the second position of the second group. The conditional probability score can include determining a ratio of the proportions. In yet some implementations, the computer system can additionally or alternatively determine a joint probability score for the discussion based on the proportions of users associated with each of the first and the second group.

In block 708 the computer system can determine, using a selected Bayesian reasoning algorithm, an informed probability score that a fully-informed user having access to all of the online discussion data would accept the first position. The informed probability score can be based on at least the conditional probability score and the digital signals. The informed probability score can indicate a fully-informed user having access to all of the online discussion data indicating the first and second positions of the first group and the second group would accept the first position of the first group.

The computer system can select an opinion among the first and second positions represented in the digital content elements as a justified opinion (block 710). The justified opinion can be selected based on the informed probability score.

The computer system can return the justified opinion in block 712. Returning the justified opinion can include transmitting information about the justified opinion to at least one user computing device of at least one of the users for presentation in a graphical user interface (GUI) display at the respective device. Transmitting the information to the at least one user computing device of the at least one of the users can cause the at least one user computing device to present the justified opinion at a top of the online forum presented in the GUI display. Transmitting the information to the at least one user computing device of the at least one of the users further can cause the at least one user computing device to push the first position of the first group or one or more other positions that do not include the justified opinion to a bottom of the online forum presented in the GUI display. In some implementations, the first position of the first group and the one or more other positions can be presented in the online forum in the GUI display in a ranked order, the ranked order being based on most popular to least popular position. A most popular position can correspond to more user responses than a least popular position. The responses can include at least one of likes, hearts, shares, or upvotes.

Any portion of the process 700 can also be performed in combination with the techniques disclosed and described in patent application Ser. No. 17/682,400, entitled INFORMED CONSENSUS DETERMINATION AMONG MULTIPLE DIVERGENT USER OPINIONS, which is incorporated herein by reference in its entirety.

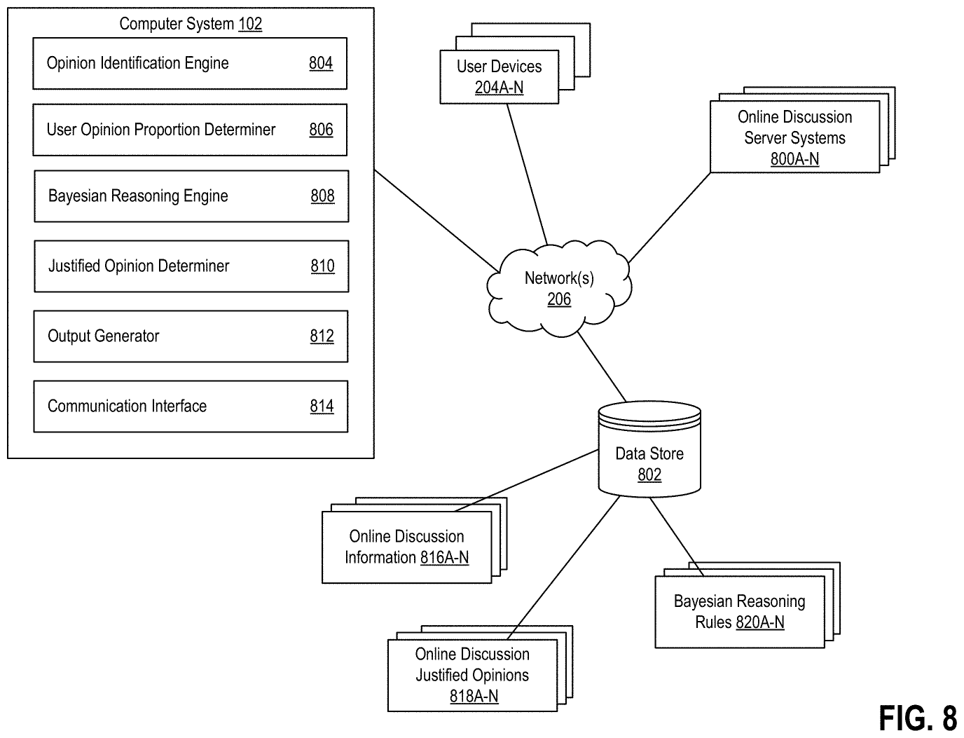

FIG. 8 is a system diagram having one or more components that can be used to perform the disclosed techniques. The computer system 102, user devices 204A-N, online discussion server systems 800A-N, and/or data store 802 can communicate (e.g., wired, wireless) via the network(s) 206.

The online discussion server systems 800A-N can be web servers, computing systems, network of computing devices/systems, and/or a cloud-based system that provides an online discussion forum to the user devices 204A-N. For example, the server systems 800A-N can provide platforms such as FACEBOOK, TWITTER, INSTAGRAM, etc. to the user devices 204A-N through which the users at the respective devices can interact with each other.

The data store 802 can be any type of data repository, memory, RAM, and/or cloud-based storage system configured to store relevant information about online discussions hosted by the online discussion server systems 800A-N, user inputs/reactions to the online discussions provided at their devices 204A-N, and/or determinations made by the computer system 102 using the techniques described herein.

For example, the data store 802 can maintain online discussion information 816A-N, which may include but is not limited to an initial discussion or post and/or any reactions, comments, feedback, likes, upvotes, downvotes, etc. that are provided by users at their devices 204A-N in response to or with respect to the initial discussion, post, or other information provided in a discussion thread. The data store 802 can maintain online discussion justified opinions 818A-N. These opinions 818A-N can be determined by the computer system 102 using the Bayesian reasoning techniques described herein. The data store 802 can maintain Bayesian reasoning rules 820A-N, which can be retrieved by the computer system 102 and used to determine the justified opinion of one or more online discussions. The rules 820A-N can include one or more of the formulas described above, such as in reference to FIG. 6.

The computer system 102 can include an opinion identification engine 804, a user opinion proportion determiner 806, a Bayesian reasoning engine 808, a justified opinion determiner 810, an output generator 812, and/or a communication interface 814. Such components are merely illustrative. The computer system 102 can include additional, fewer, or other components.

The opinion identification engine 804 can be configured to identify one or more views, opinions, positions, and/or beliefs of users who engage in a particular online discussion (or other type of discussion, such as a jury trial as described herein). For example, the engine 804 can apply semantic analysis and/or machine learning models to the received online discussion information 816A-N in order to identify each different opinion. A first opinion, for example, can be an initial post or online discussion expressing an argument A. A second opinion can be a comment made in response to the initial post expressing an argument B. The engine 804 can identify these 2 opinions using semantic analysis and/or machine learning models that are trained to identify language or other contextual cues indicating agreement and/or dissent with the initial post.

The user opinion proportion determiner 806 can be configured to determine a proportion of the users engaged with the online discussion that express the opinion(s) identified by the engine 804. The proportion can be a count, ratio, percentage, etc. The determiner 906 can determine the proportion based on, for example, counting how many users respond, like, share, and/or upvote one of the opinions. The determiner 906 can determine the proportion based on how many users view or otherwise click on one of the opinions. The determiner 906 can determine the proportion based on how many users downvote or comment negatively about one of the opinions. The determiner 906 can determine the proportion based on how many users change their comment, like, upvote, downvote, etc. based on viewing/interacting with one of the opinions. Various other techniques can be used by the determiner 806 to determine the proportion.

The Bayesian reasoning engine 808 can be configured to determine the justified opinion for the online discussion based on the opinions identified by the engine 804 and the proportions of users to opinions determined by the determiner 806. The engine 808 can retrieve and apply the Bayesian reasoning rules 820A-N to the proportions determined by the determiner 806. The engine 808 can perform any of the calculations described in reference to FIG. 6.

The justified opinion determiner 810 can be configured to identify and/or determine the justified opinion for the online discussion based on the steps performed by the Bayesian reasoning engine 808. In some implementations, the determiner 810 can be part of the engine 808. The determiner 810 can also generate a score value or probability indicating the justified opinion, as described herein. The justified opinion and/or the score value can be stored as one of the online discussion justified opinions 818A-N in the data store 802.

The output generator 812 can be configured to generate output about the justified opinion. The output can be provided to the user devices 204A-N, as described above. The output can additionally or alternatively be stored in the data store 802 and/or provided back to the computer system 102 in an iterative feedback loop to improve performance of one or more operations described herein (e.g., identifying opinions by the engine 804, determining user opinion proportions by the determiner 806, performing the Bayesian reasoning techniques by the engine 808, determining the justified opinion by the determiner 810, and/or generating output by the generator 812.

The communication interface 814 can be configured to provide communication between and amongst any of the components described with respect to FIG. 8.

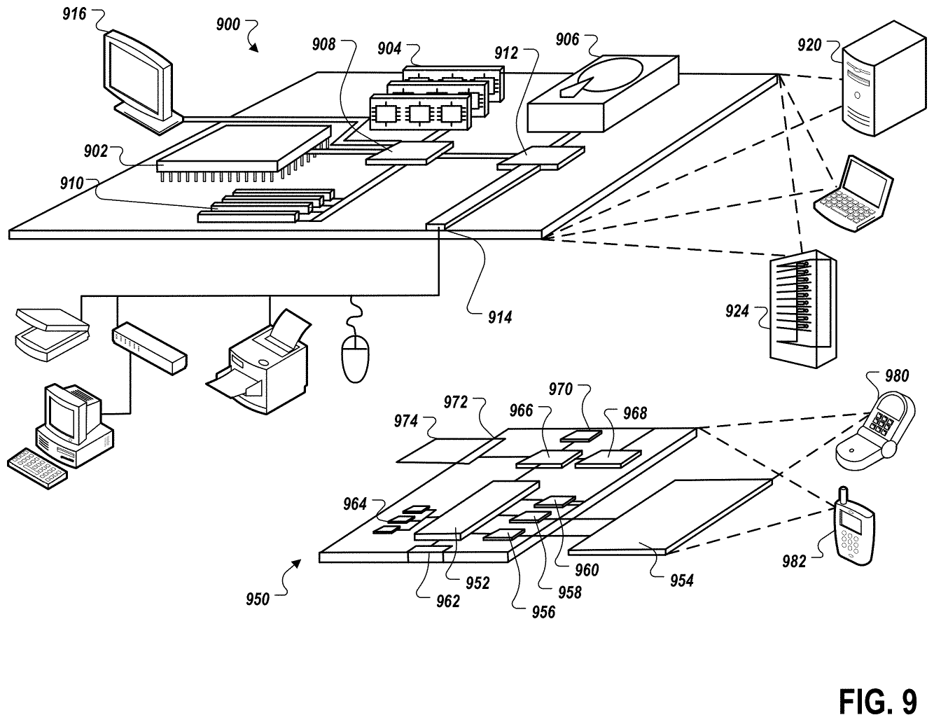

FIG. 9 shows an example of a computing device 900 and an example of a mobile computing device that can be used to implement the techniques described here. The computing device 900 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 900 includes a processor 902, a memory 904, a storage device 906, a high-speed interface 908 connecting to the memory 904 and multiple high-speed expansion ports 910, and a low-speed interface 912 connecting to a low-speed expansion port 914 and the storage device 906. Each of the processor 902, the memory 904, the storage device 906, the high-speed interface 908, the high-speed expansion ports 910, and the low-speed interface 912, are interconnected using various busses, and can be mounted on a common motherboard or in other manners as appropriate. The processor 902 can process instructions for execution within the computing device 900, including instructions stored in the memory 904 or on the storage device 906 to display graphical information for a GUI on an external input/output device, such as a display 916 coupled to the high-speed interface 908. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 904 stores information within the computing device 900. In some implementations, the memory 904 is a volatile memory unit or units. In some implementations, the memory 904 is a non-volatile memory unit or units. The memory 904 can also be another form of computer-readable medium, such as a magnetic or optical disk.

The storage device 906 is capable of providing mass storage for the computing device 900. In some implementations, the storage device 906 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 904, the storage device 906, or memory on the processor 902.

The high-speed interface 908 manages bandwidth-intensive operations for the computing device 900, while the low-speed interface 912 manages lower bandwidth-intensive operations. Such allocation of functions is exemplary only. In some implementations, the high-speed interface 908 is coupled to the memory 904, the display 916 (e.g., through a graphics processor or accelerator), and to the high-speed expansion ports 910, which can accept various expansion cards (not shown). In the implementation, the low-speed interface 912 is coupled to the storage device 906 and the low-speed expansion port 914. The low-speed expansion port 914, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 900 can be implemented in a number of different forms, as shown in the figure. For example, it can be implemented as a standard server 920, or multiple times in a group of such servers. In addition, it can be implemented in a personal computer such as a laptop computer 922. It can also be implemented as part of a rack server system 924. Alternatively, components from the computing device 900 can be combined with other components in a mobile device (not shown), such as a mobile computing device 950. Each of such devices can contain one or more of the computing device 900 and the mobile computing device 950, and an entire system can be made up of multiple computing devices communicating with each other.

The mobile computing device 950 includes a processor 952, a memory 964, an input/output device such as a display 954, a communication interface 966, and a transceiver 968, among other components. The mobile computing device 950 can also be provided with a storage device, such as a micro-drive or other device, to provide additional storage. Each of the processor 952, the memory 964, the display 954, the communication interface 966, and the transceiver 968, are interconnected using various buses, and several of the components can be mounted on a common motherboard or in other manners as appropriate.

The processor 952 can execute instructions within the mobile computing device 950, including instructions stored in the memory 964. The processor 952 can be implemented as a chipset of chips that include separate and multiple analog and digital processors. The processor 952 can provide, for example, for coordination of the other components of the mobile computing device 950, such as control of user interfaces, applications run by the mobile computing device 950, and wireless communication by the mobile computing device 950.

The processor 952 can communicate with a user through a control interface 958 and a display interface 956 coupled to the display 954. The display 954 can be, for example, a TFT (Thin-Film-Transistor Liquid Crystal Display) display or an OLED (Organic Light Emitting Diode) display, or other appropriate display technology. The display interface 956 can comprise appropriate circuitry for driving the display 954 to present graphical and other information to a user. The control interface 958 can receive commands from a user and convert them for submission to the processor 952. In addition, an external interface 962 can provide communication with the processor 952, so as to enable near area communication of the mobile computing device 950 with other devices. The external interface 962 can provide, for example, for wired communication in some implementations, or for wireless communication in other implementations, and multiple interfaces can also be used.

The memory 964 stores information within the mobile computing device 950. The memory 964 can be implemented as one or more of a computer-readable medium or media, a volatile memory unit or units, or a non-volatile memory unit or units. An expansion memory 974 can also be provided and connected to the mobile computing device 950 through an expansion interface 972, which can include, for example, a SIMM (Single In Line Memory Module) card interface. The expansion memory 974 can provide extra storage space for the mobile computing device 950, or can also store applications or other information for the mobile computing device 950. Specifically, the expansion memory 974 can include instructions to carry out or supplement the processes described above, and can include secure information also. Thus, for example, the expansion memory 974 can be provide as a security module for the mobile computing device 950, and can be programmed with instructions that permit secure use of the mobile computing device 950. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 964, the expansion memory 974, or memory on the processor 952. In some implementations, the computer program product can be received in a propagated signal, for example, over the transceiver 968 or the external interface 962.

The mobile computing device 950 can communicate wirelessly through the communication interface 966, which can include digital signal processing circuitry where necessary. The communication interface 966 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 968 using a radio-frequency. In addition, short-range communication can occur, such as using a Bluetooth, WiFi, or other such transceiver (not shown). In addition, a GPS (Global Positioning System) receiver module 970 can provide additional navigation- and location-related wireless data to the mobile computing device 950, which can be used as appropriate by applications running on the mobile computing device 950.

The mobile computing device 950 can also communicate audibly using an audio codec 960, which can receive spoken information from a user and convert it to usable digital information. The audio codec 960 can likewise generate audible sound for a user, such as through a speaker, e.g., in a handset of the mobile computing device 950. Such sound can include sound from voice telephone calls, can include recorded sound (e.g., voice messages, music files, etc.) and can also include sound generated by applications operating on the mobile computing device 950.

The mobile computing device 950 can be implemented in a number of different forms, as shown in the figure. For example, it can be implemented as a cellular telephone 980. It can also be implemented as part of a smart-phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method for automatically determining a score for a position represented in a digital content element based on digital signals derived from a group of users interacting with the digital content element in an online forum, the method comprising:
receiving, by a computing system, online discussion data, wherein the online discussion data includes the digital content element and digital signals indicating a first position represented in the digital content element and a second position represented by one or more other digital content elements, wherein the second position is in disagreement with the first position;
determining, by the computing system, proportions of users associated with each of the first group and the second group based on the one or more other digital content elements and the digital signals, wherein the proportions indicate first and second positions of an average user in each of the first group and the second group;
determining, by the computing system and based on at least the proportions and the digital signals, a conditional probability score related to the first position that a random user accepts the first position of the first group given the random user accepts the second position of the second group;
determining, by the computing system, based on at least the conditional probability score and the digital signals, and using a selected Bayesian reasoning algorithm, an informed probability score that a fully-informed user having access to all of the online discussion data indicating the first and second positions of the first group and the second group would accept the first position of the first group; and
returning, by the computing system and based on the informed probability score, information indicating a justified opinion selected from among the first position and the second position represented in the digital content element and the one or more other digital content elements, wherein the information is transmitted to at least one user computing device of at least one of the users for presentation in a graphical user interface (GUI) display.

2. The method of claim 1, wherein the digital content element is an online discussion or social media post.

3. The method of claim 2, wherein the online discussion is hosted and provided to the users at respective user computing devices by an online discussion server system, and wherein the respective user computing devices are configured to:
receive user input indicating responses taken by the respective users in response to information about the online discussion that is presented in graphical user interface (GUI) displays at the respective user computing devices; and
provide the user input to the computing system as the online discussion data.

4. The method of claim 2, wherein the digital content element is a TWEET in TWITTER.

5. The method of claim 2, wherein the digital content element is a post on INSTAGRAM.

6. The method of claim 2, wherein the digital content element is a post on FACEBOOK.

7. The method of claim 1, further comprising: determining, by the computing system, a score value for the justified opinion.

8. The method of claim 7, wherein the score value for the justified opinion is a probability value.

9. The method of claim 7, wherein the score value for the justified opinion is a likelihood that a position selected from amongst the first position and the second position is the justified opinion.

10. The method of claim 1, wherein the one or more other digital content elements include at least one of a comment, post, like, upvote, downvote, heart, share, or reply.

11. The method of claim 1, wherein the digital signals indicate at least one of (i) an amount of time between a user viewing the digital content element and the user providing a response to the digital content element at their respective user device, (ii) whether the user views the digital content element and remains inactive, or (iii) whether the user views the digital content element and provides the response.

12. The method of claim 1, wherein determining, by the computing system, a conditional probability score comprises determining a ratio of the proportions.

13. The method of claim 1, further comprising determining, by the computing system, a joint probability score for the discussion based on the proportions of users associated with each of the first and the second group.

14. The method of claim 1, wherein transmitting, by the computing system, the information to the at least one user computing device of the at least one of the users causes the at least one user computing device to present the justified opinion at a top of the online forum presented in the GUI display.

15. The method of claim 14, wherein transmitting, by the computing system, the information to the at least one user computing device of the at least one of the users further causes the at least one user computing device to push the first position of the first group or one or more other positions that do not include the justified opinion to a bottom of the online forum presented in the GUI display.

16. The method of claim 15, wherein the first position of the first group and the one or more other positions are presented in the online forum in the GUI display in a ranked order, wherein the ranked order is based on most popular to least popular position.

17. The method of claim 16, wherein a most popular position corresponds to more user responses than a least popular position.

18. The method of claim 17, wherein the responses include at least one of likes, hearts, shares, or upvotes.

19. The method of claim 1, wherein at least a portion of the one or more other digital content elements corresponds to the second position of the second group.

20. The method of claim 1, wherein at least a portion of the one or more other digital content elements corresponds to the first position of the first group.
